(19) United States
(12) Patent Application Publication
(10) Pub. No.: US 2018/0182036 A1
(43) Pub. Date: Jun. 28, 2018

(54) METHOD AND SYSTEM FOR SECURELY TRANSMITTING ORDER INFORMATION OVER A NETWORK

(71) Applicants: Christopher Thorpe, Lincoln, MA (US); David C. Parkes, Cambridge, MA (US)

(72) Inventors: Christopher Thorpe, Lincoln, MA (US); David C. Parkes, Cambridge, MA (US)

(21) Appl. No.: 15/904,796

(22) Filed: Feb. 26, 2018

Related U.S. Application Data
(63) Continuation of application No. 12/261,249, filed on Oct. 30, 2008, now abandoned.
(60) Provisional application No. 60/983,644, filed on Oct. 30, 2007.

(51) Int. Cl. G06Q 40/04; H04L 9/32; G06Q 40/06

(52) U.S. Cl. CPC G06Q 40/04; H04L 9/3218; G06Q 40/06

(57) ABSTRACT

A method and system for securely transmitting order information among multiple parties and enabling third-party verification of the order information while maintaining the secrecy of the order information.

### RELATED APPLICATIONS

This application claims priority under 35 U.S.C. § 119(e) to U.S. Provisional Application Ser. No. 60/983,644, entitled “ZERO-KNOWLEDGE PROOFS IN LARGE TRADES,” filed on Oct. 30, 2007, which is herein incorporated by reference in its entirety.

### BACKGROUND

On Wall Street, institutions often enter and exit multi-million dollar positions in equities by trading “baskets” with investment banks. To avoid revealing the equities in the baskets—this information would be easily exploited—the institutions reveal only aggregate statistics about the equities in the basket such as index membership or market sector. A large body of evidence shows that this fear of revealing the underlying equities is justified: the exploiting of information about large block trades has been demonstrated by historical price analysis as well as criminal investigations and convictions.

Several times a week, very large baskets of equities (worth hundreds of millions or even billions of dollars) are traded in the “upstairs market” on Wall Street. Institutional investors, who wish to eliminate the execution risk of exiting their positions directly, pay investment banks a premium to undertake that risk by accepting a large “basket” of orders—a large set of buy or sell orders (or both) that the institution wishes to execute all at once.

Because the institutions (understandably) fear that direct disclosure of the contents of their portfolio could be exploited, they offer banks a summary of characteristics of the portfolio risk measured by commonly used portfolio management metrics. For example, a summary might break down the equities in the basket by market sector, index membership and market capitalization to identify hedging possibilities, and the size of the positions relative to average daily volume to provide a measurement of liquidity and the potential market impact of unwinding a position.

Banks then evaluate the value of these portfolios and the risk in accepting them, based on these summaries and the state of their own inventory. Because the banks cannot identify exactly which securities are in the portfolio, they cannot completely assess the risk of accepting the basket into their inventory. Moreover, even if the incoming basket seems appropriately diversified and hedged, the bank's resulting inventory after accepting the portfolio may have very different risk characteristics. Because of the unquantified risk inherent in accepting such a portfolio, banks charge a necessary premium.

In September 2006, a number of major banks announced two new so-called ATS's (Alternative Trading Systems) with the purpose of making block trading more efficient. Citigroup, Goldman Sachs, Lehman Bros., Merrill Lynch, Morgan Stanley and UBS also announced a “Block Interest Discovery Service” (BIDS) for automatically matching large block orders without revealing them to the primary markets.

Another ECN, Liquidnet, specializes in helping institutions find counterparties for pairwise large block trades and has captured a small but significant share of order flow; their website offers up-to-date details. More relevant to our model is POSIT, another clearing network which supports both scheduled matches and ongoing crossing of block trades in protocols similar to those we propose (though they provide no correctness proofs and rely on trust in their reputation.) POSIT and similar alternative trading systems where institutions can place orders that are filled if liquidity exists are known as “dark pools”.

### SUMMARY

Using recent cryptographic techniques, such as homomorphic cryptography, verifiably correct, secrecy preserving computation and zero-knowledge proofs, one can construct a number of interesting protocols that can improve the efficiency of exchange of baskets of assets while preserving secrecy, each may be of independent interest. One protocol allows a bank to assess the impact of the basket on its inventory by learning the resulting risk characteristics of its inventory after accepting the basket, using a zero-knowledge style protocol that keeps the equities in the basket secret. Another provides for multiple institutions to trade baskets of equities in a “zero-knowledge pool” where institutions first trade with each other without revealing the quantities they wish to trade. A “remainder”' basket of interest not filled by other institutions' orders is generated and offered to banks who provide complete liquidity by valuing and bidding on the remainder; this basket's composition also remains secret. Once the bank's liquidity is added to the market, all of the institutions' trades can be executed at reasonable prices.

Zero-knowledge proofs have found many important applications in electronic commerce, from simple payment authorization and e-cash schemes to more advanced secure auctions and securities trading protocols. Some aspects of the present invention deal with interesting applications of zero-knowledge proofs to commercial transactions in the context of equity trading: basket orders and block trades.

According to one aspect, an “institution” (a firm who invests in financial markets) wishes to execute a large basket of trades, and mitigate execution risk by having an intermediary for example, an investment “bank”—take on the basket into its inventory and unwind the trades on its own. The institution might offer the basket to a small number of banks, with whom it has a relationship, to obtain the best price. Instead of revealing specific information about the equities in the basket, which could be exploited, the institution and banks can conduct a zero-knowledge protocol in which the banks learn how much the risk profile of their inventory—more generally, their utility—would change if they accepted the basket. In this process, the institution learns nothing about the bank's inventory or risk management beyond the price the bank is willing to pay, and the banks learn nothing about the basket beyond how the overall risk characteristics of their portfolio would change if they accepted the basket.

In another aspect, several parties wish to buy and sell baskets of various securities, but do not wish to reveal before the exchange takes place how many of each security they wish to buy or sell. They engage in a zero-knowledge protocol that computes the total supply and demand for each security, then calculates the remainder required for the market to reach equilibrium. The remainder can be supplied either by a “market maker” who earns a profit by facilitating the trades, or can be auctioned off to a consortium of investment banks (still in zero-knowledge) using the first protocol just introduced. Such a protocol would improve market efficiency over existing “pairwise” block trading frameworks, and could also improve liquidity by providing secrecy of traders' order sizes so that they are less fearful of that information being exploited.

Other aspects improve over coventional processes. Some conventional processes have seem limited adoption because institutions fear that knowledge of their liquidity could be exploited (e.g. in the dark pool setting), and because there is no guarantee of execution. In one embodiment, security is enhanced by encrypting the order sizes and proving the results correct, and liquidity is improved by giving the “dark pool” an efficient mechanism to find liquidity for all of the trades submitted to it, while keeping the particular equities in the institutions' baskets secret.

Szydlo proposed an application of zero-knowledge proofs to disclosing facts about equities portfolios. In his work, a hedge fund proves that its portfolio complies with its published risk guidelines without revealing the contents of its portfolio. One embodiment in the securities exchange space can be viewed as expanding this idea to proving the impact of making a particular trade on portfolio risk—without needing to reveal the securities in the trade. Further use of encryption rather than commitments provides unique advantages to some embodiments over such previous work.

Little academic research has been devoted to applications of cryptography in securities trading. Di Crescenzo focuses on privacy in stock markets (in “Privacy for the Stock Market”); Wang et al. proposes secure double auction protocols (in “Secure double auction protocols with full privacy protection”); Matsuo and Morita describe a secure electronic trading protocol (in “Secure protocol to construct electronic trading”); Bogetoft et al. develop a secure multiparty integer computation system with an application to securities exchanges (in “A practical implementation of secure auctions based on multiparty integer computations”); and Thorpe and Parkes describe a securities exchange where the prices and quantities of trades can be hidden but execution can still take place when prices match (in “Cyptographic Securities Exchange”).

According to one aspect of the present invention, a method for provable risk discovery that maintains secrecy in underlying assets of a large transaction is provided. The method comprises providing at least one rule governing a large transaction purchase between parties, encrypting at least one asset of a large transaction, providing the encrypted asset information associated with the large transaction, determining the impact on at least one risk characteristic resulting from the large transaction, and generating proof information associated with the at least one risk characteristic. According to one embodiment of the present invention, the at least one rule governing the large transaction purchase comprises at least one constraint on reporting the at least one risk characteristic associated with the large transaction. According to another embodiment of the invention, the at least one rule governing the large transaction purchase comprises at least one range of values associated with components of the large transaction. According to another embodiment of the invention, the method further comprises an act of preventing at least one participant from deriving information associated from encrypted information. According to another embodiment of the invention, preventing at least one participant form deriving information associated from encrypted information further comprises reporting provable information as at least one range of values.

According to one embodiment of the present invention, the method further comprises an act of reporting the at least one risk characteristic resulting from the large transaction. According to another embodiment of the invention, the large transaction comprises at least one of an securities trade, an equities trade, a debt security trade, a commodity trade, a derivative asset trade, an asset sale, a corporate acquisition, and a corporate merger. According to another embodiment of the invention, the large transaction comprises a securities trade, and wherein the at least one rule governing the large transaction purchase comprises a constraint on reporting of any risk associated with at least one of long and short positions, index membership, historical volatility, liquidity information, and a value for estimating risk. According to another embodiment of the invention, the large transaction comprises a securities trade, and wherein the at least one rule governing the large transaction purchase comprises a constraint on reporting of any risk associated with long and short positions.

According to one embodiment of the present invention, the large transaction comprises a securities trade, and wherein the at least one rule governing the large transaction purchase comprises a constraint on reporting of risk associated with at least one of index membership, historical volatility, liquidity information, and a value for estimating risk. According to another embodiment of the invention, the method further comprises an act of submitting by a prospective purchaser encrypted holdings information. According to another embodiment of the invention, the act of submitting by a prospective purchaser encrypted holdings information includes submitting a encrypted representation of the prospective purchaser's holdings. According to another embodiment of the invention, the method further comprises an act of providing to the prospective purchaser the encrypted asset information with the large transaction. According to another embodiment of the invention, the method further comprises an act of enabling the prospective purchaser to verify the generated proof information. According to another embodiment of the invention, generating proof information associated with the at least one risk characteristic further comprises employing a multiparty computational protocol to generate the proof information. According to another embodiment of the invention, the method further comprises an act of enabling the prospective purchaser to estimate any aspect of the risk associated with executing the purchase using a multiparty computation protocol.

According to one aspect of the present invention, a method for provable risk discovery while maintaining secrecy of the components of large securities trades is provided. The method comprises providing for submission of at least one encrypted asset of a large securities trade, providing for submission of a bidder's encrypted inventory, determining at least one risk characteristic associated with a combined portfolio, wherein the combined portfolio is generated from the assets of the large securities trade and the encrypted inventory, reporting the at least one risk characteristic associated with the combined portfolio, and generating proof information for the determined at least one risk characteristic associated with the combined portfolio. According to one embodiment of the present invention, the method further comprises an act of establishing at least one rule governing a large securities trade of equities. According to another embodiment of the invention, the at least one rule governing a large securities trade of equities defines at least one risk characteristic to use in evaluating the combined portfolio. According to another embodiment of the invention, the at least one rule governing the large securities trade includes at least one constraint on the reporting of the at least one risk characteristics.

According to one aspect of the present invention, the at least one rule governing the large securities trade establishes a range for reporting risk characteristics. According to another embodiment of the invention, the method further comprises an act of encrypting values associated with assets of the large securities trade. According to another embodiment of the invention, the assets of the large securities trade comprise at least one of an equity, a fixed income asset, a cash equivalent, a debt security, a commodity, and a derivative asset. According to another embodiment of the invention, the values associated with the assets of the large securities trade comprise at least one of an equity identifier, fixed income identifier, and a cash equivalent identifier, a unit identifier, a number of units, and a monetary value. According to another embodiment of the invention, the method further comprises an act of providing the at least one encrypted asset of a large securities trade to at least one bidder. According to another embodiment of the invention, the method further comprises an act of providing for at least one bidder to verify the determined at least one risk characteristic associated with the combined portfolio using the reported proof information and the at least one encrypted asset of a large securities trade. According to another embodiment of the invention, the act of generating further comprises employing a multiparty computational protocol to generate the proof information. According to another embodiment of the invention, the method further comprises an act of enabling the bidder to estimate any aspect of the risk associated with executing the purchase using a multiparty computation protocol.

According to one aspect of the present invention, a method for facilitating execution of large securities trades while maintaining secrecy of the components of the large securities trades is provided. The method comprises providing for submission of a plurality of at least one encrypted asset of a large securities trade to a clearing system, determining matched trades and a remainder from the submitted plurality of at least one encrypted asset of a large trade, generating proof information for the matched trades and the remainder, and providing for execution of the remainder. According to one embodiment of the present invention, the remainder comprises unmatched trades from the plurality of at least one encrypted asset of a large securities trade to a clearing system. According to another embodiment of the invention, the method further comprises an act of establishing at least one rule for participating in the large trades. According to another embodiment of the invention, the method further comprises an act of encrypting values associated with at least one asset of a large trade. According to another embodiment of the invention, the at least one asset of the large trade comprise at least one of a security, an equity, a fixed income asset, a cash equivalent, a debt security, a commodity, and a derivative asset. According to another embodiment of the invention, the values associated with at least one asset of the large trade comprise at least one of an equity identifier, fixed income identifier, and a cash equivalent identifier, a unit identifier, a number of units, and a monetary value.

According to one embodiment of the present invention, the act of generating proof information further comprises employing a multiparty computational model to generate the proof information. According to another embodiment of the invention, the method further comprises an act of providing the plurality of at least one encrypted asset of a large trades to a bidder for the remainder. According to another embodiment of the invention, the method further comprises an act of enabling the bidder to verify the generated proof information. According to another embodiment of the invention, providing for the execution of the remainder further comprises acts of providing for submission of a bidder's encrypted inventory, determining al least one risk characteristic associated with a combined portfolio, reporting the at least one risk characteristic associated with the combined portfolio, and generating proof information for the determined at least one risk characteristic associated with the combined portfolio.

According to one aspect of the present invention, a system for facilitating exchange of assets bundled into one or more baskets of assets that preserves the secrecy of the assets that make up the baskets is provided. The system comprises a clearing component adapted to accept a submission of a plurality of baskets, wherein the clearing component is further adapted to accept at least one secret offer associated with an asset as part of a basket, a trading component adapted to secretly determine overlapping offers in the plurality of baskets, wherein the trading component is further adapted to generate a remainder basket including at least one secret offer that fulfills any remaining demand from the plurality of baskets, and a proof component adapted to generate proof information for the overlapping offers in the plurality of baskets and any remainder basket. According to one embodiment of the present invention, the system further comprises an execution component adapted to execute trades for any remainder basket. According to one embodiment of the present invention, any remaining demand comprises any portion of an offer that does not overlap. According to another embodiment of the invention, the overlapping offers include at least a portion of at least one secret offer. According to another embodiment of the invention, the system further comprises an obfuscation component adapted to obfuscate information associated with at least one offer. According to another embodiment of the invention, the obfuscation component if further adapted to perform at least one of a cryptographic commitment operation, an encryption operation, a cryptographic hash function, a secret sharing operation, and a secure multi-party computation.

According to one embodiment of the present invention, the trading component is further adapted to perform a secrecy preserving operation on the at least one secret offer for the plurality of baskets. According to another embodiment of the invention, the secrecy preserving operation includes at least one of addition, subtraction, equality determination, and inequality determination on secret values. According to another embodiment of the invention, the secret offer associated with the asset includes at least one of an offer to sell, a bid to buy, an offer to enter a short position (a short sale), and a bid to cover a short position. According to another embodiment of the invention, the proof component is further adapted to preserve secrecy of the at least one secret asset while generating the proof information. According to another embodiment of the invention, the system further comprises a verification component adapted to verify correct operation of the exchange. According to another embodiment of the invention, the basket includes at least two correlated assets. According to another embodiment of the invention, the system further comprises a rule component adapted to define at least one rule for participating in an exchange of a basket of assets. According to another embodiment of the invention, the at least one rule comprises a constraint on reporting of any risk associated with at least one of long and short positions, index membership, historical volatility, liquidity information, and a value for estimating risk. According to another embodiment of the invention, the at least one rule requires submission of an encrypted quantity of zero for at least one asset listed in the asset portfolio. According to another embodiment of the invention, the at least one rule defines at least one risk characteristic to use in evaluating the asset portfolio.

According to one embodiment of the present invention, the at least one rule includes at least one constraint on the reporting of the at least one risk characteristic. According to another embodiment of the invention, the at least one rule establishes a range for reporting the at least one risk characteristic. According to another embodiment of the invention, at least one asset included in the basket comprises at least one of a security, an equity, a fixed income asset, a cash equivalent, a debt security, a commodity, and a derivative asset. According to another embodiment of the invention, the execution component is further adapted to offer any remainder to at least one bidder. According to another embodiment of the invention, the verification component is further adapted to enable the bidder to verify the generated proof information. According to another embodiment of the invention, the execution component is further adapted to determine at least one risk characteristic associated with any remainder basket, and the proof component is further adapted to generate proof information for the determined at least one risk characteristic; and wherein the system further comprises a reporting component adapted to report the at least one risk characteristic and proof information while preserving the secrecy of the at least one secret offer included in any remainder. According to another embodiment of the invention, the execution component is further adapted to accept a submission of a secret inventory by al least one bidder, generate a combined portfolio from the remainder and the secret inventory, and determine at least one risk characteristic associated with a combined portfolio, wherein the system further comprises a reporting component adapted to report the at least one risk characteristic associated with the combined portfolio, and wherein the proof component is further adapted to generate proof information for the determined at least one risk characteristic associated with the combined portfolio.

According to one embodiment of the present invention, the execution component is further adapted to accepting a clearing basket from the at least one bidder, wherein the clearing basket includes at least one secret offer for any remainder basket. According to another embodiment of the invention, the reporting component is further adapted to report a change in at least one risk characteristic for the secret inventory resulting from the combined portfolio. According to another embodiment of the invention, the execution component is further adapted to accepting a clearing basket from at least one bidder, wherein the clearing basket includes at least one secret offer for at least a portion of any remainder basket. According to another embodiment of the invention, the clearing basket includes a cost associated with accepting the at least the portion of any remainder basket. According to another embodiment of the invention, the execution component is further adapted to determine a transaction to dispose of any part of any remainder using at least one of the submitted clearing baskets. According to another embodiment of the invention, the verification component is further adapted to verify the secretly determined overlapping offers in the plurality of baskets against the published rules of the exchange. According to another embodiment of the invention, the verification component is further adapted to verify overlapping offers in the plurality of baskets against the published rules of the exchange, and verify the at least one risk characteristic.

According to one aspect of the present invention, a system for provable risk discovery of an asset portfolio that maintains the secrecy of the underlying assets is provided. The system comprises a clearing component adapted to accept a submission of an asset portfolio, by a first party, wherein the clearing component is further adapted to accept an at least one secret asset as part of the asset portfolio, wherein the clearing component is further adapted to accept a submission of another asset portfolio, by a second party, and wherein the clearing component is further adapted to accept an at least one secret asset as part of the another asset portfolio, and a trading component adapted to secretly generate a combined portfolio from the asset portfolio and the another asset portfolio. According to one embodiment of the present invention, the system further comprises an obfuscation component adapted to obfuscate information associated with at least one asset. According to another embodiment of the invention, the obfuscation component is further adapted to perform at least one of a cryptographic commitment operation, an encryption operation, a cryptographic hash function, a secret sharing operation, and a secure multi-party computation. According to another embodiment of the invention, the system further comprises a risk component adapted to determine at least one risk characteristic associated with the combined portfolio. According to another embodiment of the invention, the system further comprises a risk component adapted to determine a change in at least one risk characteristic of at least one of the asset portfolio and the another asset portfolio resulting from the generation of the combined portfolio.

According to one embodiment of the present invention, the clearing component is further adapted to perform a secrecy preserving operation on the asset portfolio and the another asset portfolio. According to another embodiment of the invention, the system further comprises a proof component adapted to generate proof information for the secrecy preserving operation. According to another embodiment of the invention, the secrecy preserving operation includes at least one of addition, subtraction, equality determination, and inequality determination on obfuscated information. According to another embodiment of the invention, the clearing component is further adapted to accept a submission of at least one additional asset portfolio, by at least one additional party, and wherein the trading component is further adapted incorporate the at least one additional asset portfolio into the combined portfolio. According to another embodiment of the invention, the obfuscation component is further adapted to obfuscate a value of zero for a quantity of an asset listed in any submitted asset portfolio. According to another embodiment of the invention, the asset portfolio comprises at least one of a security, an equity, a debt security, a commodity, a derivative asset, a corporate asset, and a corporate holding. According to another embodiment of the invention, the clearing component is further adapted to accept a representation of an asset inventory as any of the submitted asset portfolios.

According to one embodiment of the present invention, the obfuscated information includes an identifier for an asset and an obfuscated value for a quantity of the asset. According to another embodiment of the invention, the system further comprises a bid component adapted to accept a bid for the combined asset portfolio, wherein the bid is based at least in part the determined at least one risk characteristic. According to another embodiment of the invention, the system further comprises a rule engine adapted to establish at least one rule governing purchase of the asset portfolio, According to another embodiment of the invention, the at least one rule comprises a constraint on reporting of any risk associated with at least one of long and short positions, index membership, historical volatility, liquidity information, and a value for estimating risk. According to another embodiment of the invention, the at least one rule requires submission of an encrypted quantity of zero for at least one asset listed in the asset portfolio. According to another embodiment of the invention, the at least one rule defines at least one risk characteristic to use in evaluating the asset portfolio. According to another embodiment of the invention, the at least one rule includes at least one constraint on the reporting of the at least one risk characteristic.

According to one embodiment of the present invention, the at least one rule establishes a range for reporting the at least one risk characteristic. According to another embodiment of the invention, the assets of the asset portfolio comprise at least one of an equity, a fixed income asset, a cash equivalent, a debt security, a commodity, and a derivative asset. According to another embodiment of the invention, the identifier comprises at least one of an equity identifier, fixed income identifier, a cash equivalent identifier, and a unit identifier. According to another embodiment of the invention, the trading component is further adapted to provide obfuscated information to at least one bidder. According to another embodiment of the invention, the system further comprises a verification component adapted to verify the determined at least one risk characteristic using the reported proof information.

According to one aspect of the present invention, a computer implemented method for securely proving fair allocation of commissions associated with offers Lo exchange secret assets is provided. The method comprises the acts of providing at least one rule governing the exchange of secret assets, providing for publication of at least one risk characteristic associated with a basket of assets, accepting the basket of assets, wherein the basket of assets includes at least one secret asset, generating, secretly, the at least one risk characteristic, accepting at least one clearing basket and an associated commission, wherein the clearing basket includes at least one secret asset, and determining, secretly, an allocation of the assets in the basket to the accepted at least one clearing basket that generates a fair allocation of the associated commissions.

According to one aspect of the present invention, a computer implemented method for provable risk discovery of an asset portfolio of assets that maintains the secrecy of the assets is provided. The method comprises providing an invertible encryption operation, providing for evaluation of an asset portfolio, wherein the asset portfolio includes at least one encrypted asset encrypted using the invertible encryption operation, determining at least one risk characteristic associated with the asset portfolio, generating proof information for the determined at least one risk characteristic associated with the asset portfolio, and reporting the at least one risk characteristic and the proof information.

According to one aspect of the present invention, a trading system for facilitating exchange of assets bundled into a basket of assets that maintains secrecy of the assets that make up the baskets is provided. The trading system comprises generation means for generating a basket, where the means for generating the basket is further adapted to generate an obfuscated asset as part of the basket, submission means for accepting a plurality of baskets to a clearing system, computational means for performing secrecy preserving operations on the obfuscated offer to determine overlap between the obfuscated assets and any other asset, and proving means for proving a result of the secrecy preserving operations correct, wherein the proving means is further adapted to preserve the secrecy of the underlying values while proving the result. According to one embodiment of the present invention, the computation means is further adapted to determine any remainder from the matches between the obfuscated assets. According to another embodiment of the invention, the system further comprises execution means for performing any required transaction to fulfill any remainder, wherein the execution means is further adapted to preserve the secrecy of the underlying assets while fulfilling any remainder. According to another embodiment of the invention, the system further comprises verification means for verifying the correct operation of the exchange of assets. According to another embodiment of the invention, the verification means is further adapted to verify the secrecy preserving operations on the obfuscated offer to determine overlap between the obfuscated assets and any other assets. According to another embodiment of the invention, the computational means is further adapted to generate a remainder basket that fulfills any remaining demand from the plurality of baskets. According to another embodiment of the invention, the system further comprises risk calculation means for determining at least one risk characteristic associated with a basket.

According to one aspect of the present invention, a computer implemented method for facilitating exchange of assets bundled into one or more baskets of assets that maintains secrecy of the assets is provided. The method comprises providing for submission of a plurality of baskets to a clearing system, wherein at least one basket comprises at least one secret offer associated with an asset, determining overlapping offers for an asset, determining any remainder from the overlapping offers, wherein any remainder comprises a remaining demand including at least one secret offer associated with an asset, and generating proof information for the overlapping offers in the plurality of baskets and the remaining demand in any remainder. According to one embodiment, the at least one basket comprises at least one secret offer includes each of the plurality of baskets. According to one embodiment of the present invention, the method further comprises an act of generating a remainder basket, wherein the remainder basket comprises at least one secret offer for an asset in any remainder. According to another embodiment, the method further comprises at least one rule to limit the size or risk characteristics of the remainder basket by limits on the set of overlapping offers allowable to exchange.

According to another embodiment of the invention, the overlapping offers include at least a portion of at least one secret offer. According to another embodiment of the invention, the method further comprises an act of providing for obfuscation of information associated with at least one offer, wherein the at least one secret offer comprises the obfuscated information. According to another embodiment of the invention, the act of providing for obfuscation includes an act of providing at least one of a cryptographic commitment operation, an encryption operation, a cryptographic hash function, a secret sharing operation, and a secure multi-party computation. According to another embodiment of the invention, the act of determining overlapping offers in the plurality of baskets includes an act of performing a secrecy preserving operation on the at least one secret offer for the plurality of baskets.

According to one embodiment of the present invention, the secrecy preserving operation includes at least one of addition, subtraction, equality determination, and inequality determination on secret values. According to another embodiment of the invention, the secret offer associated with the asset includes at least one of an offer to sell, a bid to buy, an offer to enter a short position (a short sale), and a bid to cover a short position. According to another embodiment of the invention, the method further comprises an act of preserving secrecy of the at least one secret asset while generating the proof information. According to another embodiment of the invention, an act of providing for verification of the overlapping offers. According to another embodiment of the invention, the basket includes at least two correlated assets. According to another embodiment of the invention, the method further comprises an act of establishing at least one rule for participating in an exchange of a basket of assets. According to another embodiment of the invention, the at least one rule comprises a constraint on reporting of any risk associated with at least one of long and short positions, index membership, historical volatility, liquidity information, and a value for estimating risk. According to another embodiment of the invention, the at least one rule requires submission of an encrypted quantity of zero for at least one asset listed in the asset portfolio. According to another embodiment of the invention, the at least one rule defines at least one risk characteristic to use in evaluating the asset portfolio.

According to one aspect of the present invention, the at least one rule includes at least one constraint on the reporting of the at least one risk characteristic. According to another embodiment of the invention, the at least one rule establishes a range for reporting the at least one risk characteristic. According to another embodiment of the invention, at least one asset included in the basket comprises at least one of a security, an equity, a fixed income asset, a cash equivalent, a debt security, a commodity, and a derivative asset. According to another embodiment of the invention, the method further comprises an act of offering any remainder basket to at least one bidder. According to another embodiment of the invention, the method further comprises an act of enabling the bidder to verify the proof information. According to another embodiment of the invention, the method further comprises the acts of determining at least one risk characteristic associated with any remainder basket, generating proof information for the at least one risk characteristic, and reporting the at least one risk characteristic and proof information while preserving the secrecy of the at least one secret offer included in any remainder basket.

According to one embodiment of the present invention, the method further comprises the acts of providing for submission of a secret inventory by at least one bidder, determining at least one risk characteristic associated with a combined portfolio, wherein the combined portfolio comprises the remainder basket and the secret inventory, reporting the at least one risk characteristic associated with the combined portfolio, and generating proof information for the at least one risk characteristic associated with the combined portfolio. According to another embodiment of the invention, the method further comprises an act of accepting a clearing basket from the at least one bidder, wherein the clearing basket includes at least one secret offer for any remainder. According to another embodiment of the invention, the act of reporting the at least one risk characteristic associated with the combined portfolio comprises an act of reporting a change in at least one risk characteristic for the secret inventory resulting from the combined portfolio. According to another embodiment of the invention, the method further comprises an act of accepting a clearing basket from at least one bidder, wherein the clearing basket includes at least one secret offer for at least a portion of any remainder. According to another embodiment of the invention, the clearing basket includes a cost associated with accepting the at least the portion of any remainder basket. According to another embodiment of the invention, the method further comprises an act of determining a transaction to dispose of any part of any remainder using at least one of the submitted clearing baskets.

According to one embodiment of the present invention, the act of providing for verification of the determined overlapping offers includes an act of providing for verification of overlapping offers in the plurality of baskets against the at least one rule for participating in an exchange of a basket of assets at least one rule governing of the exchange. According to another embodiment of the invention, the method further comprises the acts of providing for verification of overlapping offers in the plurality of baskets against the at least one rule for participating in an exchange, and providing for verification of the at least one risk characteristic.

According to one aspect of the present invention, a computer implemented method for provable risk discovery of an asset portfolio that maintains the secrecy of the underlying assets is provided. The method comprises providing for submission of an asset portfolio, by a first party, wherein the asset portfolio includes at least one secret asset, providing for submission of at least one other asset portfolio wherein the at least one other asset portfolio includes at least one secret asset, and generating a combined portfolio from the asset portfolio and the at least one other asset portfolio, wherein the combined portfolio includes at least one secret asset. According to one embodiment of the present invention, the method further comprises an act of providing for obfuscation of information associated with at least one asset, wherein the at least one secret asset includes the obfuscated information.

According to another embodiment of the invention, the act of providing for obfuscation includes an act of providing at least one of a cryptographic commitment operation, an encryption operation, a cryptographic hash function, a secret sharing operation, and a secure multi-party computation. According to another embodiment of the invention, the method further comprises an act of determining at least one risk characteristic associated with the combined portfolio. According to another embodiment of the invention, the method further comprises an act of determining a change in at least one risk characteristic of at least one of the asset portfolio and the at least one other asset portfolio resulting from the generation of the combined portfolio.

According to one embodiment of the present invention, the act of generating a combined portfolio from the asset portfolio and the another asset portfolio includes an act of performing a secrecy preserving operation on the asset portfolio and the another asset portfolio. According to another embodiment of the invention, the method further comprises an act of generating proof information for the secrecy preserving operation. According to another embodiment of the invention, the secrecy preserving operation includes at least one of addition, subtraction, equality determination, and inequality determination on obfuscated information. According to another embodiment of the invention, the assets of the asset portfolio comprise at least one of an equity, a fixed income asset, a cash equivalent, a debt security, a commodity, and a derivative asset. According to another embodiment of the invention, the method further comprises an act of providing for submission of an obfuscated value of zero for a quantity of an asset listed in any submitted asset portfolio. According to another embodiment of the invention, the asset portfolio comprises at least one of a security, an equity, a debt security, a commodity, a derivative asset, a corporate asset, and a corporate holding.

According to one embodiment of the present invention, the method further comprises an act of providing for submission of a representation of an asset inventory as any of the submitted asset portfolios. According to another embodiment of the invention, the obfuscated information includes an identifier for an asset and an obfuscated value for a quantity of the asset. According to another embodiment of the invention, the method further comprises an act of accepting a bid for the asset portfolio, wherein the bid is based at least in part the determined at least one risk characteristic. According to another embodiment of the invention, the method further comprises an act of establishing at least one rule governing purchase of the asset portfolio. According to another embodiment of the invention, the at least one rule comprises a constraint on reporting of any risk associated with at least one of long and short positions, index membership, historical volatility, liquidity information, and a value for estimating risk, According to another embodiment of the invention, the at least one rule requires submission of an encrypted quantity of zero for at least one asset listed in the asset portfolio. According to another embodiment of the invention, the at least one rule defines at least one risk characteristic to use in evaluating the asset portfolio. According to another embodiment of the invention, the at least one rule includes at least one constraint on the reporting of the at least one risk characteristic. According to another embodiment of the invention, the at least one rule establishes a range for reporting the at least one risk characteristic.

According to one embodiment of the present invention, the identifier comprises at least one of an equity identifier, fixed income identifier, a cash equivalent identifier, and a unit identifier. According to another embodiment of the invention, the method further comprises an act of providing obfuscated information to at least one bidder. According to another embodiment of the invention, the method further comprises an act of providing for at least one bidder to verify the determined at least one risk characteristic using the reported proof information.

According to one aspect of the present invention, a computer-readable medium having computer-readable signals stored thereon that define instructions that, as a result of being executed by a computer, instruct the computer to perform a method for facilitating exchange of assets bundled into one or more baskets of assets that maintains secrecy of the assets is provided. The method comprises providing for submission of a plurality of baskets to a clearing system, wherein at least one basket comprises at least one secret offer associated with an asset, determining overlapping offers for an asset, determining any remainder from the overlapping offers, wherein any remainder comprises a remaining demand including at least one secret offer associated with an asset, and generating proof information for the overlapping offers in the plurality of baskets and the remaining demand in any remainder. According to one embodiment, the at least one basket comprises at least one secret offer includes each of the plurality of baskets. According to one embodiment of the present invention, the method further comprises an act of generating a remainder basket, wherein the remainder basket comprises at least one secret offer for an asset in any remainder.

According to another embodiment of the invention, the overlapping offers include at least a portion of at least one secret offer. According to another embodiment of the invention, the method further comprises an act of providing for obfuscation of information associated with at least one offer, wherein the at least one secret offer comprises the obfuscated information. According to another embodiment of the invention, the act of providing for obfuscation includes an act of providing at least one of a cryptographic commitment operation, an encryption operation, a cryptographic hash function, a secret sharing operation, and a secure multi-party computation. According to another embodiment of the invention, the act of determining overlapping offers in the plurality of baskets includes an act of performing a secrecy preserving operation on the at least one secret offer for the plurality of baskets.

According to one embodiment of the present invention, the secrecy preserving operation includes at least one of addition, subtraction, equality determination, and inequality determination on secret values. According to another embodiment of the invention, the secret offer associated with the asset includes at least one of an offer to sell, a bid to buy, an offer to enter a short position (a short sale), and a bid to cover a short position. According to another embodiment of the invention, the method further comprises an act of preserving secrecy of the at least one secret asset while generating the proof information. According to another embodiment of the invention, an act of providing for verification of the overlapping offers. According to another embodiment of the invention, the basket includes at least two correlated assets. According to another embodiment of the invention, the method further comprises an act of establishing at least one rule for participating in an exchange of a basket of assets. According to another embodiment of the invention, the at least one rule comprises a constraint on reporting of any risk associated with at least one of long and short positions, index membership, historical volatility, liquidity information, and a value for estimating risk. According to another embodiment of the invention, the at least one rule requires submission of an encrypted quantity of zero for at least one asset listed in the asset portfolio. According to another embodiment of the invention, the at least one rule defines at least one risk characteristic to use in evaluating the asset portfolio.

According to one aspect of the present invention, the at least one rule includes at least one constraint on the reporting of the at least one risk characteristic. According to another embodiment of the invention, the at least one rule establishes a range for reporting the at least one risk characteristic. According to another embodiment of the invention, at least one asset included in the basket comprises at least one of a security, an equity, a fixed income asset, a cash equivalent, a debt security, a commodity, and a derivative asset. According to another embodiment of the invention, the method further comprises an act of offering any remainder basket to at least one bidder. According to another embodiment of the invention, the method further comprises an act of enabling the bidder to verify the proof information. According to another embodiment of the invention, the method further comprises the acts of determining at least one risk characteristic associated with any remainder basket, generating proof information for the at least one risk characteristic, and reporting the at least one risk characteristic and proof information while preserving the secrecy of the at least one secret offer included in any remainder basket.

According to one embodiment of the present invention, the method further comprises the acts of providing for submission of a secret inventory by at least one bidder, determining at least one risk characteristic associated with a combined portfolio, wherein the combined portfolio comprises the remainder basket and the secret inventory, reporting the at least one risk characteristic associated With the combined portfolio, and generating proof information for the at least one risk characteristic associated with the combined portfolio. According to another embodiment of the invention, the method further comprises an act of accepting a clearing basket from the at least one bidder, wherein the clearing basket includes at least one secret offer for any remainder. According to another embodiment of the invention, the act of reporting the at least one risk characteristic associated with the combined portfolio comprises an act of reporting a change in at least one risk characteristic for the secret inventory resulting from the combined portfolio. According to another embodiment of the invention, the method further comprises an act of accepting a clearing basket from at least one bidder, wherein the clearing basket includes at least one secret offer for at least a portion of any remainder. According to another embodiment of the invention, the clearing basket includes a cost associated with accepting the at least the portion of any remainder basket. According to another embodiment of the invention, the method further comprises an act of determining a transaction to dispose of any part of any remainder using at least one of the submitted clearing baskets.

According to one embodiment of the present invention, the act of providing for verification of the determined overlapping offers includes an act of providing for verification of overlapping offers in the plurality of baskets against the at least one rule for participating in an exchange of a basket of assets at least one rule governing of the exchange. According to another embodiment of the invention, the method further comprises the acts of providing for verification of overlapping offers in the plurality of baskets against the at least one rule for participating in an exchange, and providing for verification of the at least one risk characteristic.

According to one aspect of the present invention, a computer-readable medium having computer-readable signals stored thereon that define instructions that, as a result of being executed by a computer, instruct the computer to perform a method for provable risk discovery of an asset portfolio that maintains the secrecy of the underlying assets is provided. The method comprises providing for submission of an asset portfolio, by a first party, wherein the asset portfolio includes at least one secret asset, providing for submission of at least one other asset portfolio wherein the at least one other asset portfolio includes at least one secret asset, and generating a combined portfolio from the asset portfolio and the at least one other asset portfolio, wherein the combined portfolio includes at least one secret asset. According to one embodiment of the present invention, the method further comprises an act of providing for obfuscation of information associated with at least one asset, wherein the at least one secret asset includes the obfuscated information.

According to another embodiment of the invention, the act of providing for obfuscation includes an act of providing at least one of a cryptographic commitment operation, an encryption operation, a cryptographic hash function, a secret sharing operation, and a secure multi-party computation. According to another embodiment of the invention, the method further comprises an act of determining at least one risk characteristic associated with the combined portfolio. According to another embodiment of the invention, the method further comprises an act of determining a change in at least one risk characteristic of at least one of the asset portfolio and the at least one other asset portfolio resulting from the generation of the combined portfolio.

According to one embodiment of the present invention, the act of generating a combined portfolio from the asset portfolio and the another asset portfolio includes an act of performing a secrecy preserving operation on the asset portfolio and the another asset portfolio. According to another embodiment of the invention, the method further comprises an act of generating proof information for the secrecy preserving operation. According to another embodiment of the invention, the secrecy preserving operation includes at least one of addition, subtraction, equality determination, and inequality determination on obfuscated information. According to another embodiment of the invention, the assets of the asset portfolio comprise at least one of an equity, a fixed income asset, a cash equivalent, a debt security, a commodity, and a derivative asset. According to another embodiment of the invention, the method further comprises an act of providing for submission of an obfuscated value of zero for a quantity of an asset listed in any submitted asset portfolio. According to another embodiment of the invention, the asset portfolio comprises at least one of a security, an equity, a debt security, a commodity, a derivative asset, a corporate asset, and a corporate holding.

According to one embodiment of the present invention, the method further comprises an act of providing for submission of a representation of an asset inventory as any of the submitted asset portfolios. According to another embodiment of the invention, the obfuscated information includes an identifier for an asset and an obfuscated value for a quantity of the asset. According to another embodiment of the invention, the method further comprises an act of accepting a bid for the asset portfolio, wherein the bid is based at least in part the determined at least one risk characteristic. According to another embodiment of the invention, the method further comprises an act of establishing at least one rule governing purchase of the asset portfolio. According to another embodiment of the invention, the at least one rule comprises a constraint on reporting of any risk associated with at least one of long and short positions, index membership, historical volatility, liquidity information, and a value for estimating risk. According to another embodiment of the invention, the at least one rule requires submission of an encrypted quantity of zero for at least one asset listed in the asset portfolio. According to another embodiment of the invention, the at least one rule defines at least one risk characteristic to use in evaluating the asset portfolio. According to another embodiment of the invention, the at least one rule includes at least one constraint on the reporting of the at least one risk characteristic. According to another embodiment of the invention, the at least one rule establishes a range for reporting the at least one risk characteristic.

According to one embodiment of the present invention, the identifier comprises at least one of an equity identifier, fixed income identifier, a cash equivalent identifier, and a unit identifier. According to another embodiment of the invention, the method further comprises an act of providing obfuscated information to at least one bidder. According to another embodiment of the invention, the method further comprises an act of providing for at least one bidder to verify the determined at least one risk characteristic using the reported proof information.

According to another aspect of the present invention, a computer-readable medium having computer-readable signals stored thereon that define instructions that, as a result of being executed by a computer, instruct the computer to perform any of the preceding method elements, individually or in combination.

### BRIEF DESCRIPTION OF THE DRAWINGS

FIG. 1 is a flow chart of an example process for facilitating exchange of assets while maintaining secrecy of the underlying assets;

FIG. 2A is a flow chart of an example process for facilitating exchange of assets while maintaining secrecy of the underlying assets;

FIG. 2B is a flow chart of the continuation of the example process for facilitating exchange of assets while maintaining secrecy of the underlying assets;

FIG. 3 is a block diagram of an example system for performing secrecy preserving operations on assets according to one embodiment of the present invention;

FIG. 4 is a block diagram of an example system for performing secrecy preserving operations on assets according to one embodiment of the present invention;

FIG. 5 is a block diagram of an example system for performing secrecy preserving operations on assets according to one embodiment of the present invention;

FIG. 6 is a flow chart of an example process for facilitating the exchange of assets while maintaining secrecy of the underlying assets according to one embodiment of the present invention;

FIG. 7 is a flow chart of an example process for secretly calculating risk associated with an asset portfolio according to one embodiment of the present invention;

FIG. 8 is a flow chart of an example process for generating and clearing a remainder basket from secrecy preserving asset baskets according to one embodiment of the present invention;

FIG. 9 is a flow chart of an example process for generating obfuscated information according to one embodiment of the present invention; and

FIG. 10 is a flow chart of an example process for secretly determining risk associated with a combined portfolio according to one embodiment of the present invention.

### DETAILED DESCRIPTION

According to one aspect, presented is a useful new mechanism that facilitates the atomic exchange of large baskets of securities in a combinatorial exchange. Cryptography prevents information about the securities in the baskets from being exploited, enhancing trust. Some embodiments of the exchange offer institutions who wish to trade large positions a new alternative to existing methods of block trading: they benefit from reduced transaction costs by taking advantage of other institutions' available liquidity, while third party liquidity providers guarantee execution—preserving their desired portfolio composition at all times. In one embodiment of an exchange, institutions submit encrypted orders which are crossed, leaving a “remainder”. The exchange proves facts about the portfolio risk of this remainder to third party liquidity providers without revealing the securities in the remainder, the knowledge of which could also be exploited. The third parties learn either (depending on the setting) the portfolio risk parameters of the remainder itself, or how their own portfolio risk would change if they were to incorporate the remainder into a portfolio they submit. They submit bids on the commission, and the winner supplies necessary liquidity for the entire exchange to clear. It is realized for some embodiments, this guaranteed clearing, coupled with external price discovery from the primary markets for the securities, eliminates the difficult combinatorial optimization problem. Proving how taking on the remainder would change risk parameters of one's own portfolio, without revealing the remainder's contents or its risk parameters, is a useful protocol of independent interest.

In one embodiment, considered is a cryptographic combinatorial securities exchange, where entire baskets of securities may be bought or sold, rather than single positions. This has important applications for portfolios of securities where entering the various positions in the portfolio piecemeal would subject the investor to increased portfolio risk. For example, if a large portfolio is optimized to have certain correlations among its assets, and it takes hours to find a counterparty to fill various positions in the portfolio, the orders filled first will have a different risk profile than the intended portfolio.

In another example, say a particular investor believes that Toyota will outperform Ford, but does not wish to undertake any risk from general market or automotive sector movements. He takes a long position in Toyota and a short position in Ford of the same size. If the automotive sector or the general markets move up, then the gains in Toyota will offset the losses in Ford. The investor's problem is that he needs to enter these trades at exactly the same time. If he is taking a large position in this portfolio, then he would be exposed to risk in general market and automotive sector movements between the time he closed the first and second position. Some embodiments of the exchange, which provides for atomic trades that are guaranteed to clear, eliminates such risks.

There are known problems with the existing alternative trading systems (ATS's) for block trades. For instance, institutions still fear that knowledge of their liquidity can be exploited in various ways, and rely on information brokers like Liquidnet who strictly limit membership to the trading network to parties who are only trading for liquidity reason. A second problem is that there is typically no guarantee of execution. Finally, there is no mechanism for trading an entire basket at once, eliminating portfolio risk while the execution of the trades is going on.

At least some of these concerns are ameliorated according to various embodiments by not only keeping trades secret until the market is to clear but also proving the results correct; liquidity is also improved by providing an efficient mechanism to guarantee execution for all of the trades submitted to it—while still keeping the particular equities in the incoming institutions' baskets secret; and it provides an atomic basket trading paradigm.

Further it is realized that currently for large basket trades (involving more than one security), the transactions are too complex for the pairwise trade matching that existing ATS's like Liquidnet and Pipeline offer. Institutions who need to trade a basket of securities atomically to maintain the integrity of a diversified portfolio are not willing to undertake the risk of executing the trades one security at a time. Thus, institutional investors who wish to trade several large positions at once in a basket order typically hire an investment bank. They describe the basket to a small number of trusted investment banks who agree to provide liquidity, without disclosing the exact securities that comprise the basket in advance—information that could be exploited. When deciding how much to charge for liquidating a basket, the banks learn only certain risk parameters, such as index membership, daily trading volume, and market correlation; these enable them to estimate their risk and costs in the absence of complete data.

Some embodiments of a cryptographic combinatorial exchange provide the improved efficiency of institution-to-institution trading with the reduced portfolio risk from guaranteed execution of atomic basket trades. Cryptography makes such an exchange feasible by providing necessary trust: exploitable data remain secret, and every action and result can be proven correct.

In one embodiment of a combinatorial exchange, institutions submit baskets of buy and sell orders which are filled by other institutions' sell and buy orders (respectively). The unfilled orders comprise a remainder basket, which clears the exchange when filled by a cooperating third party (assumed to be an investment bank). Prices for each security are determined by the primary markets, so that the exchange need only discover trading interest.

Because direct disclosure of the remainder would permit exploitation of that information, institutions submit their baskets in an encrypted form which can then be used to derive an encrypted remainder. Then, the exchange can prove facts about this encrypted remainder to the investment banks without revealing its contents. Moreover, described is how to construct a proof of how a bank's risk on a portfolio changes by taking on the remainder, by using encrypted forms of the remainder and that portfolio. This enables the banks to accurately estimate commissions to charge the exchange for providing the necessary liquidity.

The guarantee of order execution makes this market extremely attractive. The institution need not wait for another trader to indicate interest: if there is opposite interest, it will be used; if there is not, then the bank provides the liquidity. This offers an unprecedented market efficiency: the exchange offers a mix-and-match of cheap institution-to-institution liquidity wherever possible, only using the more expensive bank-provided liquidity where necessary. It also means that institutions can count on their order being filled completely in a reasonable amount of time, eliminating portfolio risk from partial fills and reducing the risk of holding securities while trying to trade them.

Another advantage of guaranteed order execution is that it prevents exploitation of even dark market centers by orders designed to search for liquidity; traders do not need to show their hand by entering an order into the dark pool because they are guaranteed their order will be filled.

This approach appears to be more compatible with recent securities regulations. In the United States, the National Best Bid and Offer (NBBO) system and National Market System (regulated by the so-called “Reg NMS”) govern the prices at which publicly traded securities may be exchanged; Europe recently adopted a new Markets in Financial Instruments Directive (MiFID) that has a similar mandate. Regulatory compliance is a significant challenge for block trading systems that wish to hide data, and it may be difficult to legally operate an exchange in which standing limit orders are meant to be kept secret from any national market. Our model, which only discovers liquidity and derives prices from the primary markets, are expected to be be more compatible with ever-tighter regulation.

The inventors believe this to be the first characterization of a cryptographic combinatorial exchange: a number of participants submit bundles to buy and sell goods (in one example, securities), and the market finds an optimal allocation of trades to maximize the benefit of all participants. While such combinatorial exchanges typically require significant computation to find optimal allocations (even defining “optimal” in such an exchange is challenging), some embodiments of the exchange make two important simplifications that eliminate the hard combinatorial problem. First, prices are defined externally by the primary markets, and second, the clearing of the remainder via a third party means that all bundles are filled and the market clears at equilibrium.

According to another aspect, one protocol provides a bank, for example, with the ability to accurately quantify the portfolio risk associated with taking on a basket of equities; improving price discovery for the value of the equities. In yet another aspect the efficiency and security of block trades is improved.

It is assumed that one of skill in the art is familiar with reasonable cryptographic assumptions about the cryptographic primitives used and the description of basic operations that can be implemented using a number of widely accepted cryptographic building blocks that are used to as a basis in describing some embodiments. For example, using Paillier's homomorphic cryptosystem relies on the composite residuosity assumption; Pedersen commitments require the discrete logarithm assumption; etc.

### Cryptographic Primitives

In various embodiments, our protocols employ a framework for zero-knowledge proofs that supports secure, verifiable, and efficient computation of linear functions over encrypted data. Described are the operations used, with reference to methods from the existing literature that support these operations in various ways. In one alternative embodiment, we use the notion of a partially trusted third party “prover” P who proves facts about the encrypted data, as certain embodiments of the protocols supporting these operations use such a party. In our formal treatment of the primitives, we refer to this party as P, but prefer the more descriptive word “system”' for this party in the context of the applied protocols.

### Encryption and Decryption

In one embodiment, a triple of efficient functions E(m,r), D(c), and Dᵣ(c,r) are provided, such that, given c=E(m,r), D(c) deterministically outputs the plaintext m (and, generally, r as well) for any valid ciphertext c, and Dᵣ(c,r) deterministically outputs the plaintext m for any valid pair c,r. The value r is a “random help value” that is selected at random for each encryption operation.

The encryption function E is a semantically secure, probabilistic encryption function. This means that an adversary given only c cannot efficiently learn anything about m or r; moreover, an adversary given m₀, m₁ and a random encryption

$${c}_{i} = E ( {m}_{i} , r ) , i {←}^{R} \{ 0 , 1 \}$$

cannot efficiently determine whether i=0 with probability significantly greater than ½. Important for our applications, this also implies that an adversary cannot tell whether two different ciphertexts c₀, c₁ are encryptions of the same or different values.

The encryption function E is public: anyone can encrypt; the decryption function D is private, and only those who know it can decrypt any ciphertext c; the decryption function Dᵣ is public: anyone can decrypt a ciphertext c (recovering m) if provided the random help value r.

The particular scheme used that provides these functions must support the following arithmetic operations over encrypted values.

### Operations on Encrypted Values

Given only the ciphertext c [symbol] =E(m [symbol] ,r [symbol] ) and similar ciphertexts cⱼ,cₖ, the prover P can prove in “zero-knowledge” certain facts about. the associated plaintext mᵢ,mⱼ,mₖ, P can prove any relation between an unencrypted value m [symbol] and encrypted values cⱼ,cₖ by encrypting c [symbol] =E(m [symbol] ,r [symbol] ), revealing r [symbol] to any verifiers, and then proving the relation for c [symbol] ,cⱼ,cₖ. The relation among the plaintexts and notation of the corresponding relation among the ciphertexts follows:
Equality: mₖ=mᵢ (cₖ≡cᵢ).
Inequalities: mₖ≠mᵢ; mₖ<mᵢ; etc. (cₖ [symbol] [symbol] cₖ<cᵢ;cₖ≥cᵢ; etc.)
Addition: mₖ=mᵢ−mⱼ (cₖ≡cₖ⊕cⱼ).
Additive inverse: mₖ=−mᵢ (cₖ⊕cᵢ≡E(0)).
Multiplication: m [symbol] =m [symbol] ×mⱼ (cₖ≡cᵢ⊗cⱼ).
Multiplicative inverse: mₖ=mᵢ⁻¹ (cₖ⊗cᵢ≡E(1)). (where existent)
Interval Proofs: a<mₖ≤b for publicly known constants a, b
(E(a) [symbol] cₖ≤E(b)), (roughly equivalent to inequalities: one can easily construct one from the other.)

These operations are supported differently depending on the encryption scheme employed. Paillier's homomorphic encryption scheme can be extended to support this set of operations as described by Jurik et al. in “A generalization a simplification and some applications of Paillier's probabilistic public-key system”; by Parkes, Rabin, Shieber, Thorpe in “Practical Secrecy Preserving, verifiably correct and trustworthy auctions”; and by Thorpe and Parkes in “Cryptographic Securities Exchanges,” Szydlo's aforementioned early research on zero-knowledge proofs in portfolio analysis employs the homomorphic properties of Pedersen commitments supported by Schnorr OR proofs and simple interval proofs to build his protocols (in “Risk assurance for hedge funds using zero knowledge proofs”).

Rabin, Servedio and Thorpe recently proposed a very different model that uses a combination of a simple encryption scheme with proofs of correctness for these operations; in this scheme the prover has an arbitrarily small probability of successfully “cheating”, but only efficient and secure cryptographic commitments are required to support verification of correctness (in “Highly Efficient Secrecy Preserving Proofs of Correctness of Computations and Applications”). In their work, no further computational assumptions are necessary for the security of the encryption.

### Cryptographic Combinatorial Securities Exchange

According to one aspect a cryptographic combinatorial securities exchange offers basket traders guaranteed execution and efficient liquidity discovery. It keeps information completely secret until it is necessary, eliminating opportunities for fraud, and proves every result correct without revealing unnecessary information.

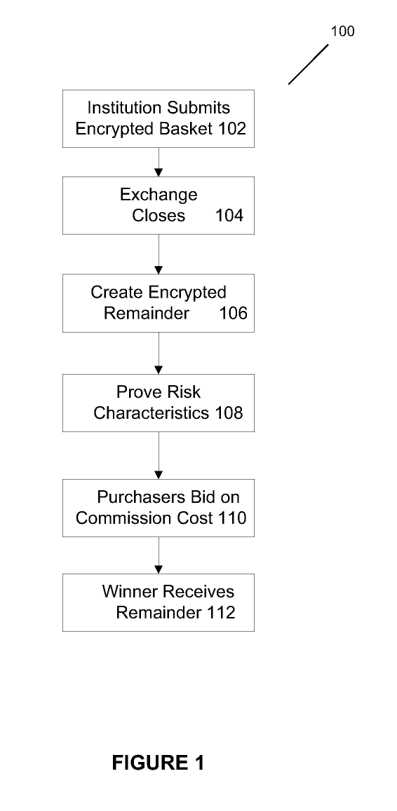

Generally stated as one example of a process, 100 (FIG. 1), for a secrecy preserving exchange of assets, institutions submit encrypted baskets 109; the exchange closes 104; the exchange creates an encrypted remainder 106 and proves risk characteristics to third party liquidity providers 108; these investment banks bid on their commission 110; and the winning bank clears the market by liquidating the remainder 112. Prices clear at prices determined by the primary markets.

Because these and other specific protocols supporting secrecy-preserving computation over private inputs are well-documented in the literature, and one should appreciated that various embodiments do not depend on specific features other than those just described, further, some detail regarding particular implementations of individual cryptographic choices is unnecessary in light of the broader concepts associated with various aspects of the present invention. One should appreciate that implementors of embodiments will be able to select an underlying cryptosystem appropriate to their specific needs at the time. Further one should appreciate that the above protocols are practically efficient and provide clear support for the interval proofs that are essential to some embodiments. According to another aspect, discussed are implications of the partial trust in a third party and mechanisms, according to some embodiments, for mitigating such trust below.

### An Example Protocol

Consider n trading parties P [symbol] , where i∈[1,n], each of which submits a basket Bᵢ, comprised of m securities where Sⱼ, j∈[1,m]. Thus in a universe of 6 securities, B [symbol] , P [symbol] 's, basket, might be (0,−20000,32000,0,45000,0 [symbol] . The double subscript notation Bᵢⱼ denotes the (unencrypted) quantity of security j in P [symbol] 's basket; in our example, B₃₅=45000. E(Bᵢⱼ) is the encrypted form of one such value. Zeroes are included to hide the number of distinct equities in the basket, though a fixed basket size simplifies future computations.

Since most underlying cryptosystems employ modular arithmetic, short positions can be easily represented as “negative numbers” (that is, very large numbers that are the additive inverses of the corresponding positive number).

According to one embodiment, an encryption of a basket of equities is a set of quantities, one for each equity in the universe, including zeros. For visual comfort, we may write E(B [symbol] ) as the encryption of an entire basket, which is in fact m separate encryptions: [symbol] E(Bᵢ₁), E(Bᵢ₂), . . . , E(Bᵢₘ) [symbol] .

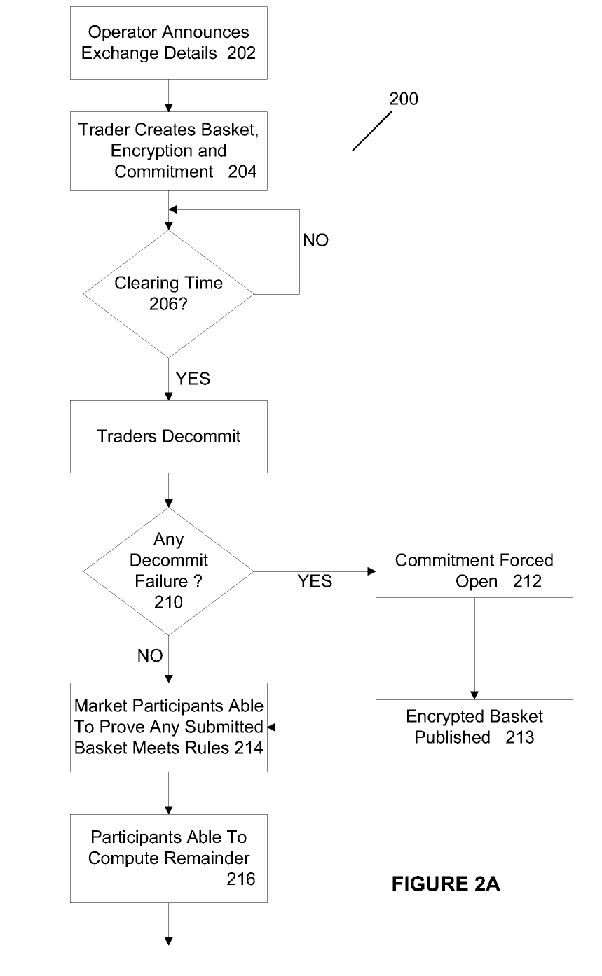

One implementation of an example process, 200 (FIG. 2), embodies the following steps:

At 202, the operator announces exchange details, for example, the market operator announces clearing times, the universe of equities to be traded on the exchange, and any rules governing the composition of baskets participating in the exchange. If time-lapse cryptography (TLC) or a similar technique used to enforce nonrepudiation requires posting of public information (for example, a public TLC encryption key according to some embodiments), the market operator posts that.

At 204, before each clearing time, each trader P [symbol] chooses which equities she wishes to trade and creates basket B [symbol] and encrypted form E(B [symbol] ). Each then creates a commitment to her basket, Comᵢ (E(Bₖ)), and publishes that commitment where the exchange and other parties to the transaction can see them.

At 206, when the clearing time is reached 206 YES, the traders decommit 208, in one example they publish encryptions of their baskets and any proof necessary to prove their prior commitments were valid. (In another example, if a trader fails to decommit 210 YES, and a nonrepudiation technique is used, the commitment is forced open and the encryption of his basket is published at 213.) If all decommitments are received, 210 NO, the process continues at 214.

At 214, either the market operator, or each individual P [symbol] , for example, proves, using the now public E(Bᵢ), that the basket P [symbol] submitted conforms to any announced basket composition requirements. Because P [symbol] encrypted the basket herself, she is capable of proving her basket meets any exchange requirements without the cooperation of the market operator.

At 216, everyone can compute the “remainder” basket B_{R} by computing a function on all of the encryptions of traders' baskets. Table B illustrates an example of this on unencrypted values, while using our standard notation, we write:

$$\begin{matrix}{B}_{R} = 〈 {{⊕}^{η}}_{i = 1} E ( {B}_{l 1} ) , . . . , {{⊕}^{η}}_{i = 1} E ( {B}_{i , m} ) 〉 & ( 1 ) \\ = 〈 E ( {\sum }_{i = 1}^{η} {B}_{i 1} , . . . , E ( {\sum }_{i = 1}^{η} {B}_{i , m} ) 〉 & ( 2 )\end{matrix}$$

TABLE B
Example set of cross-clearing portfolios with a “remainder”

| Security | B₁ | B₂ | B₃ | B₄ | R |
|---|---|---|---|---|---|
| ABC | +500 | −200 | 0 | 0 | +300 |
| DEF | +300 | −800 | +300 | +200 | 0 |
| GHI | 0 + | +100 + | −300 + | 0 = | −200 |
| JKL | +200 | 0 | −400 | +300 | +100 |
| MNO | −800 | 0 | +500 | 0 | −300 |

At 218, the market operator privately decrypts the baskets, and obtains the unencrypted remainder basket.

At 220, the market operator proves facts about the composition of the remainder basket B_{R} to the third party liquidity providers, who individually or jointly determine transaction costs for the remainder basket, at 222, and agree to provide liquidity to the pool.

At 224, after the market-clearing liquidity has been secured, the market operator announces the protocol is complete, and issues each institution a proof of its share of the commission based on the other encrypted baskets at 226. (One should appreciate that other cryptographic protocols may be employed to provide any required anonymity for the traders). The market clears at prices fixed in accordance with a published standard procedure. For example, the market might clear at the midpoint between the bid and ask quoted on the current primary market, or an agreement to trade at the volume-weighted average price for a particular period of time. The mechanics of clearing securities trades vary according to specific implementation. In this example, all parties trade with a trusted intermediary who accepts all long positions and distributes all short positions, clearing the market.

### Zero-Knowledge Proofs of Trade Impact on Portfolio Risk

Szydlo appears to be the first to propose the application of zero-knowledge proofs to disclosing facts about equities portfolios. In his work, a hedge fund proves that its portfolio complies with its published risk guidelines without revealing the contents of its portfolio. Szydlo's proofs are not situated in a transactional context, but rather in the context of a hedge fund reporting portfolio risk characteristics that are based on the claimed securities in the portfolio. In contrast, some embodiments are interested in proving portfolio risk in order to liquidate a newly derived remainder basket computed from a combination of many incoming baskets, not a private portfolio that will never be revealed—as in Szydlo.

Another difference in certain embodiments is the use of encryption over commitments. Encryptions allow an exchange to issue proofs about combinations of the institutions' baskets without requiring their continued involvement. One should appreciate that were one to employ commitments, institutions would be required to decommit their baskets before computing the remainder: providing an opportunity for repudiation. While the homomorphic Pedersen commitments Szydlo employs are may he thought of as more efficient than homomorphic encryptions, desired is nonrepudiation: once a basket is committed to in a transaction, the trader may not later refuse to reveal that basket.

Employing encryptions directly achieves advantages over commitments in spite of any perceived efficiency disadvantage. Encryptions may also mitigate so-called protocol completion incentive problems, because traders who lose their incentive to participate cannot benefit from refusing to complete the protocol.

Described is how large basket orders are traded by revealing portfolio risk measurements of the baskets themselves, rather than the actual risk undertaken by the banks accepting the baskets. According to some embodiments, proposed is a secure system that makes price discovery for basket trades more accurate by offering banks limited but more specific characteristics of their actual risks—how the risk of their inventory changes—not the characteristics of the incoming basket.

In one embodiment, the system acts as a partially trusted third party, accepting encrypted forms of the institution's portfolio and the bank's book, and providing a set of risk characteristics of the bank's resulting book after the integration of the equities in the portfolio. The system proves these characteristics correct in “zero knowledge” based on the encrypted inputs, to assure the bank that it received an accurate picture even if it does not win the bid. (Presently, only winners can verify the correctness of the submitted values because they are the only party who ever discovers the actual contents of the basket.) In an alternative embodiment, the system provides information on how the bank's risk profile will be changed by accepting the institution's portfolio rather than giving direct analysis of the risk make up of the resulting book.

One should appreciate references to a bank's “inventory” include situations where the bank may submit any representative portfolio to the system and compute the risk of accepting the basket on the basis of risk changes in this particular portfolio. Use of a representative portfolio may be due to reluctance to reveal the exact portfolio to even a partially trusted third party, or to achieve improved price discovery by a specially tailored portfolio. Additionally it should be understood that the present invention is not limited to exchanges with banks or institutions, other purchasers or sellers may participate.

### Mechanics of One Embodiment

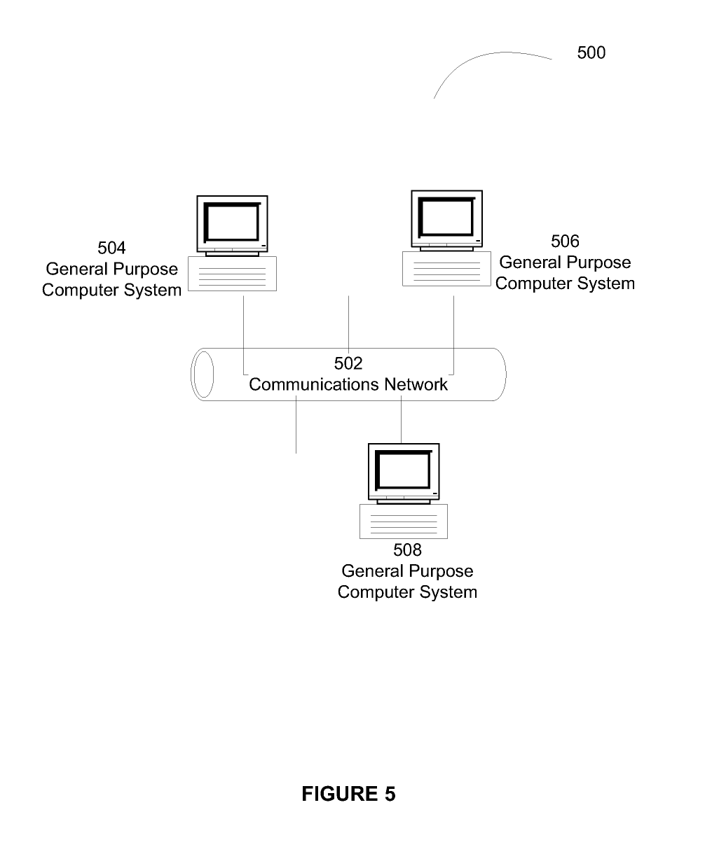

One example embodiment. of a protocol, process 600 (FIG. 6), is comprised of a series of steps: the parameters of the transaction are agreed on 602; the two transacting parties publish their encrypted information to all 604; the two parties send secret information to the partially trusted third party 606; the third party issues proofs to one party about the portfolio risk 608; and that party verifies the proofs using the published information 610.

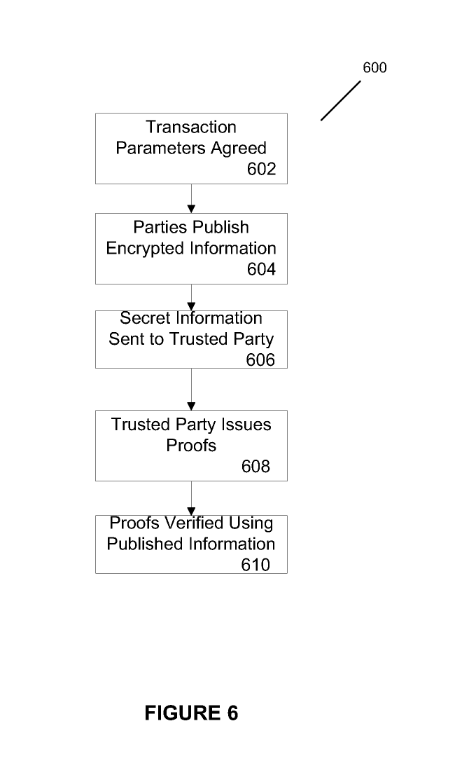

Another implementation of an example process, 700 (FIG. 7), embodies the following steps:

At 702, the institution and bank agree on a set of risk characteristics to evaluate in the resulting book. This step protects the secrecy of the institution's information while providing enough information to the bank to quote an accurate price. The institution may also require that certain outputs be reported as “bounds”, where the results are only quoted accurately enough for the bank to price the portfolio by proving they lie within a certain small range. This maybe of extreme importance to prevent the banks from “backing out” private information from the encrypted data by carefully constructed queries. According to one embodiment, agreement may also come in the form of participation in an exchange according to established rules. Further the parties may agree to a form of encryption to use to obfuscate information associated with submitted assets.

At 704, the institution prepares a list of triples:
Identifying code (ticker, CUSIP, etc.) (in one embodiment this information is not encrypted)
Number of shares (in one embodiment this information is encrypted)
Value quotation (e.g. previous close×shares) (in one embodiment this information is encrypted)

The encryptions are carried out in accordance with the agreed cryptographic protocol. Providing the value quotation is a matter of convenience, as the encrypted value can be computed as the encrypted product of public previous close price and the encrypted number of shares, other embodiments omit the value quotation.

The institution shares these encrypted data with the system and the banks. According to one embodiment, for complete security the basket should include all equities in the trading universe, with encrypted zero values for quantity and total value being used for any equities not in the portfolio. Short positions are naturally represented by negative values. This also allows the institution to keep the total number of equities in the basket secret if desired. One should appreciate that listing all equities is not necessary, but that the greater number of equities listed with encrypted zero values the greater the ability to conceal the actual make up of an underlying portfolio. Some embodiments, list only a few additional equities, some as little as one additional equity, although others list many, and some list all relevant equities. Relevant equities can be agreed in advance and may be based on market sector for example, agreement may extend to the number of additional listing to use, parties may also agree to a minimum number of additional listing, etc. At 706, each bank prepares a similar data set of triples for its inventory, into which the basket would be integrated, and shares this encrypted portfolio with the system. It does not need to share it with the institution.

At 708, for each bank, the system privately decrypts the institution's portfolio and the bank's inventory and computes the resulting portfolio and its risk characteristics.

At 710, it then creates a list of statistics about the resulting portfolio and proofs of their correctness as described below. In one embodiment, the statistics describe the resulting portfolio. In another, the statistics describe the change in risk characteristics on the purchaser's portfolio by accepting the seller's assets.

At 712, it reveals these proofs to each bank, which in turn verifies that they were computed correctly using its encrypted portfolio and the encrypted portfolio provided by the institution.

At 714, the bank examines the new risk characteristics of the resulting portfolio, estimates carrying and execution costs and submits a bid to the institution. (In practice, the computed characteristics might be sent to a portfolio management software system that compares the “before” and “after” portfolios to automatically estimate risk and hedging costs). The bid may be accepted or rejected by the institution at 716. In some embodiments, multiple bids may be solicited, and in others, bids for parts of a seller's inventory, and the system may calculate an optimal group of bids. Optionally, a system may calculate a winning bid, and a seller is not given an opportunity to accept or reject the winning bid or combination of winning bids.

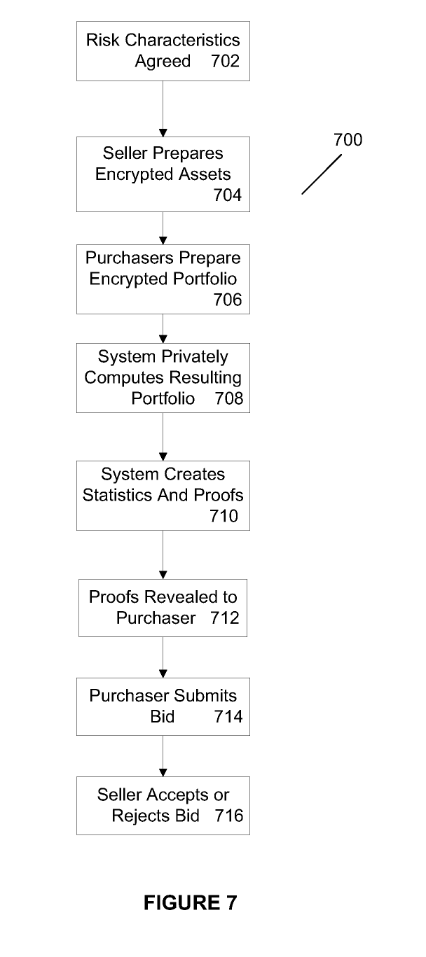

With reference to FIG. 8, shown is an example process 800, for performing trades on secret assets while maintaining the secrecy of the underlying assets. At step 802, a participant submits a basket of assets. The basket of assets includes obfuscated information about the particulate assets in the basket. The obfuscation process may be performed using a number of procedures, for example using encryptions of values associated with assets, another method can include the use of cryptographic commitments, other methods may include secret sharing operations, and yet other embodiments may employ secure multi-party computation. At step 804, the system determines overlapping offers from within the baskets, for example an offer to buy an equity X, is matches with an offer to sell the same equity X. The offers to sell and buy do not have to match exactly, in other words if the total demand is for the sale of 1,000,000 shares but the demand to purchase is only 750,000, the 750,000 portion describes the overlap. One should appreciate the overlap will typically be defined by the aggregation of the demand from all the baskets, and does not need to match exactly the quantities for sale or purchase. In some embodiments, the quantities associated with the assets in the basket are obfuscated using any of the techniques described herein. In one example, the quantities associated with assets in the baskets are encrypted, and overlapping offers are determined using secrecy preserving operations on the encrypted values. Once the overlapping offers are determined, at 806 (NO) there is no remainder from the baskets and proof information is generated at 810 to enable verification of the operation of the exchange. In one embodiment, the proof information is used to verify that the baskets submitted by each of the participants meets will all required rules for participation. In another embodiment, the proof information is used to verify the calculation of the overlapping offers, At 806 (YES), there is unfilled demand left over from the baskets, and a remainder basket is generated at 808 to satisfy the remaining demand. At 810, generation of the proof information include proof information for the generation of the remainder basket.

At 812, the overlapping offers are executed in conjunction with the execution of any remainder at 814. In one embodiment the remainder calculated at 814 comprises most but not necessarily all of the demand for the assets in the submitted baskets. In one example, the remainder covers a substantial portion of any non-overlapping demand, so that any demand not covered by the remainder represents small quantities of the assets. In one embodiment, steps 812 and 814 occur simultaneously. In another embodiment step 812 may occur when binding agreement has been reached on the execution of the remainder, for example bids for the remainder have been accepted.

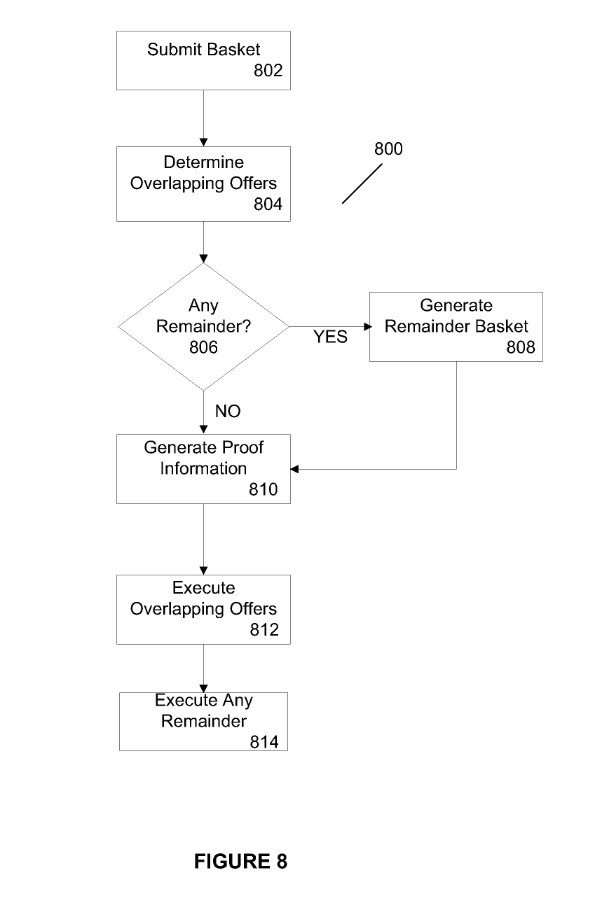

With reference to FIG. 9, shown is an example process 900, for creation of a basket of assets with obfuscated information. Obfuscation may be performed using a number of procedures, for example using encryptions of values associated with assets, another method can include the use of cryptographic commitments, other methods may include secret sharing operations, and yet other embodiments may employ secure multi-party computation. In one example, assets are obfuscated at 902 using encryption.

Consider n trading parties P [symbol] , where i∈[1,n], each of which submits a basket Bᵢ, comprised of m securities Sⱼ, where j∈[1,m]. Thus in a universe of 6 securities, B₃, P₃'s basket, might be [symbol] 0,−20000,32000,0,45000,0 [symbol] . The double subscript notation Bᵢⱼ denotes the (unencrypted) quantity of security j in P [symbol] 'basket; B [symbol] =45000. E(Bᵢⱼ) is the encrypted form of one such value. Zeroes may be included to hide the number of distinct equities in the basket, though a fixed basket size simplifies future computations in some embodiments.

According to one embodiment, an encryption of a basket of equities is a set of quantities, one for each equity in the universe, including zeros. For visual comfort, we may write E(B [symbol] ) as the encryption of an entire basket, which is in fact m separate encryptions: [symbol] E(B [symbol] ), E(B [symbol] ), . . . , E(B Z,999 ) [symbol] bundles into a basket at 904. In another embodiment, basket of intended trades is obfuscated by encrypting the quantity to trade for each security listed in the exchange: positive to buy, negative to sell, or zero, once all the assets have been encrypted they are bundled into a basket at 904. At 906, party wishing to trade the basket in a secrecy preserving fashion submits the basket to a trading system at 906. Process 900 may be used by a participant as a method for preparing baskets of asset for use in other methods, before beginning for example process 800 FIG. 8, or may be used to generate an asset portfolio in for example process 1000, or as a method to generate an encrypted basket for use in process 100.

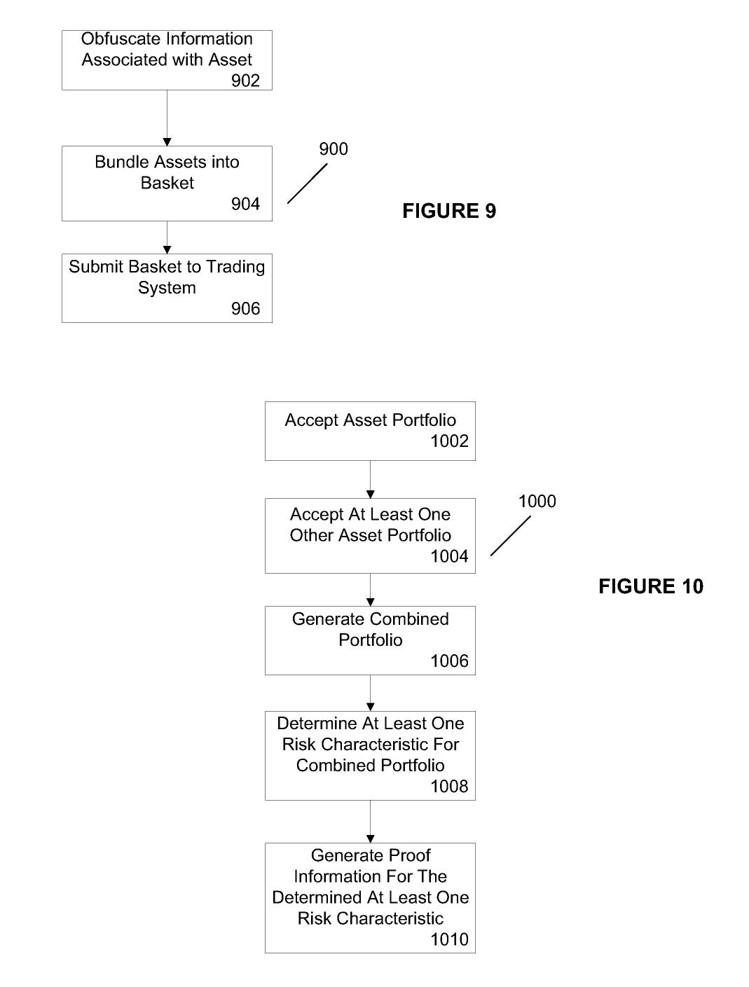

With reference to FIG. 10, shown is an example of a process 1000, for determining at least one risk characteristic for a combined portfolio. At step 1002, an asset portfolio is accepted for evaluation. The asset portfolio comprises at least one asset that is obfuscated to preserve the secrecy of the underlying asset. The obfuscation can take place using a number of methodologies, for example, using encryption on quantities of assets of the portfolio, although one should appreciate that other secrecy preserving operations may also be used (e.g. secret sharing, cryptographic commitment, secure multi-party computation, etc.). At step 1004, at least one other asset portfolio is accepted. The at least one other asset portfolio also includes obfuscated information associated with the assets that make up the portfolio. In one example the listing of assets in the asset portfolio also includes obfuscated values of zero for quantities of some assets. At step 1006 a combined portfolio is generated that combined the various positions in the submitted asset portfolios. According to one embodiment, the combined portfolio is generated in a secrecy preserving manner. Once the combined portfolio has been generated, secrecy preserving operations are performed on the combined portfolio to determine at least one risk characteristic for the combined portfolio. Alternatively, the overall change in risk to one of the submitted portfolios may be evaluated, so that the change in risk to the submitted portfolio is calculated for the resulting combined portfolio. At 1010, proof information is generated to verify in a secrecy preserving manner the risk calculations. One should appreciate that one can prove the result of any risk management calculation that can be expressed as a polynomial function of the quantities of the at least one asset in the basket without revealing new information about those quantities, for example using the encryption operations discussed herein, and more generally using other obfuscation techniques.

Additionally, one should appreciate that some assets listed in a basket need not be encrypted at all. In some embodiments, small quantities of assets may be combined in a basket, where certain assets are not encrypted. In one embodiment, its is realized that for smaller quantities the risks associated with revelation and/or the ability to exploit knowledge of small quantities is minimized simply by the small quantity itself. In some embodiments, parties may agree in advance to a threshold that establishes whether a quantity must be encrypted, optionally even where the rules provide for required encryption above a threshold, a party may encrypt below the threshold as well.

### What Information Should Be Revealed?

Presently, institutions submit the characteristics of their baskets to banks in spreadsheets with specific numbers in each category. This process “leaks” information, especially where the number of equities in a particular category is small. Occasionally, the information can create obvious implications: for example, if there is only one equity listed in the telecommunications sector, comprising 89,000 shares whose total value is S3,546,650, the bank probably has an excellent idea of the company's name. Institutions sometimes “white out” some information in their basket descriptions to prevent such information leakage, usually to eliminate obvious information leaks.

Yet even when such information is redacted, rigorous statistical analyses of the information submitted can still yield information about the composition of the baskets, and this is also possible in more complex situations where a large number of equities contribute to one line-item. Since values are often supplied to the penny, if the number of equities, total dollar amount as of a particular market close, and total number of shares is known, it is possible that a computer could efficiently search the possible baskets created by equities in that sector and propose a small number of alternatives to the bank. While we have no reason to believe that the reports are being so exploited by the banks, eliminating any potential information leakage while still providing accurate risk assessments is an important benefit of some embodiments of our proposed system.

Because the cryptographic framework we describe supports interval proofs on encrypted values (or functions on encrypted values) the system can reveal approximate risk characteristics that are sufficient for price discovery but are more resistant to statistical analysis to back out the composition of the baskets. For instance, instead of reporting the sector breakdown exactly, the system can report values rounded to the nearest percentage point or thousands of dollars or shares. Although there is no reason that institutions can't submit baskets with such obfuscated data, they would not be able to prove it correct without cryptography. The ability to reveal “just enough” information (while still proving it correct) is an important feature of one embodiment.

### How the Information is Revealed

Some embodiments depart from conventional methodologies which only prove portfolio risk of a single portfolio, by revealing facts about a hypothetical portfolio that results after a bank with a large inventory (which it wants to keep private) accepts a basket of equities (which the institution trading the basket wants to keep private.)

In some implementations the system privately knows the combined portfolio, and the bank knows its own portfolio and the encrypted quantities of equities in the incoming basket. According to one embodiment, to reveal a fact, the system obtains the result of the desired computation and sends the result to the bank, along with special verification data that allow the bank to verify the result. The form of these data depends on the type of system employed; in this work we assume a general framework based on the cryptographic primitives described above. The bank then performs a computation using the hidden data provided by the institution and data from its own portfolio, and verifies the result of the computation using the special verification data provided by the system.

The following primitive operations are used to reveal the portfolio risk profile:
Compute a linear function of multiple encrypted values, or encrypted values and constants
Decide whether one encrypted value is greater than another
Decide whether one encrypted value is (not) equal to another

### Computing the Combined Portfolio in an Example Embodiment

After the system knows both the institution's incoming basket and the bank's inventory, it verifiably computes the new quantities for every equity in the universe by creating a “combined portfolio” with the combined quantity and value of each equity. (Again, we assume that short positions are represented by a negative number of shares and negative total value). This would occur for example, after 706 in process 700. In other embodiments, the system does not compute quantities for every equity rather it computers on only those submitted, in another embodiment the system may add to the list of equities, inserting additional equities and zero values associated with them to further obscure the components of a block or basket of assets being exchanged.

According to one embodiment, computing this verifiable, encrypted combined portfolio is simple; in many cases, the banks can also compute the encrypted combined portfolio (but importantly learn nothing from it.) For each equity in the portfolio, the system computes the sum of the institution's and bank's number of shares and total value. It then publishes the new encrypted portfolio and proves to the bank that this encrypted portfolio is equivalent to the sum of the bank's inventory and the encrypted institution's basket. One should appreciate in some embodiment both the baskets and the bank's inventory are represented as a list of triples: (EquityID, E(shares), E(value). Using the cryptographic primitives above, the system adds up the number of shares and the values for each equity in the universe to obtain a new combined portfolio.

The encrypted values comprising this “combined portfolio” can now be used to prove facts about it in zero-knowledge as described in greater detail below with reference to certain examples.

### Portfolio Value and Dividends

In most cases, the incoming basket order will involve long and short trades, and an element of the risk is the “skew”—the difference between the total value of the short and long trades. Sometimes, when an institution is trading a basket with a significant skew (or even entirely one-sided) it may not wish the site of the skew to be known. In this case, the bank might respond not with a specific cash price, but rather a discount quotation, an agreement to accept the equities in the basket at a particular volume-weighted average price, or other quotation based on the market prices of the equities after they are revealed. Because the bank can accurately assess its risk profile in accepting these, it can offer more competitive discounts or execution quotes for less risky baskets, or, similarly, charge more for a riskier basket.

The institution and the bank may agree to reveal:
The full value of the long and short sides of the trade:
The system provides a proof that allows the bank to decrypt the sum of all long trades and the sum of all short trades.
The value or range of the “skew” only:
In this case, the system provides the bank a proof of the sum of the portfolio's value plus all long positions' values minus all short positions' to values. It might reveal the precise skew, or only that the skew lies within a particular interval.
No information about the value of the incoming basket:
In this case, the position values, quotes, and number of shares must all be kept secret; the risk profile of the resulting portfolio can still be evaluated by other means.

The information to reveal may be agreed in advance. In one embodiment, participation represents agreement to abide by whatever choice was made regarding revelation of skew.

A similar approach can be applied to dividends, where the bank receives aggregate calculations of historical and expected dividend payments, so that it can estimate any dividend payments it will make (for short sales) and receive (for long positions).

### Portfolio Composition Statistics

For risk management and hedging calculations, the bank may wish to know the composition of the combined portfolio based on various factors, including:
Market sector (technology, health care, consumer goods, etc.)
Market capitalization
Index membership
Dividend amount (as a percentage of share price)
Average daily trading volume (possible in terms of both shares and notional value)
Historical price volatility

Using an implementation of the system, the institution need not reveal any information about the incoming basket's sector breakdown—for example, if there are balanced long and short trades in technology, and zero trades in utilities, this is indistinguishable to the bank from a portfolio with zero technology and balanced utilities trades, provided that the balanced trades do not change the risk profile of the bank's inventory. This provides additional secrecy to the institution while still meeting the needs of the bank.

The system calculates the portfolio composition and proves it to the accepting bank, who verifies the result using its own encrypted portfolio and the encrypted basket provided by the institution. Because the system can offer proofs that each sector's breakdown lies within a particular interval (say to the percentage point or 1/10 of 1%), the institution can reveal enough information for the bank to offer an accurate price while making reconstruction of the portfolio infeasible.

Using the general cryptographic operations described above, the bank now can compute verifiable breakdowns for the various aspects of the portfolio, for example, as follows.

The notation S is used to represent the total number of shares, and V to represent total portfolio value. Each of the [symbol] elements' shares are written as s [symbol] , . . . , s [symbol] ; their total values are v₁, . . . , v. In an example of a breakdown of market capitalization, s₁ might represent the sum of shares of securities whose market cap is over S10 billion, and s₁0 represents microcaps of less than S50 million. One should appreciate that which “bucket” an equity belongs to is public information for any breakdown; the bank simply doesn't know the equities' quantities. The bank now has the encryptions of these values:

E(S), E(V), E(sᵢ), E(vᵢ).

In the following illustrative example, the system proves the breakdown of equities based on the value of each bucket v [symbol] in the breakdown. A similar technique can be applied to the number of shares, although the market value breakdown is generally more useful. We assume a constant K that reflects the desired granularity of the data as a number of “units”; for percentage points, the protocol would set K=100.

Step 1. Because the bank knows the breakdown for each equity (e.g. market cap, market sector, etc.), it can compute encrypted sums of the number of shares and total value for each item in the breakdown by summing up the encrypted number of shares and total value from the combined portfolio. The bank also recalls the encrypted total number of shares and encrypted total value of the basket. We recall that this is the combined portfolio, where any long and short trades in the incoming basket have already been incorporated into the bank's inventory.

Step 2. The system first proves the sums are correct, namely, E(S)≡Σ [symbol] [symbol] (sᵢ) and E(V)≡Σ [symbol] [symbol] E(vᵢ). (In this case, Σ represents applying the ⊖ operator to calculate an encryption of the sum of two encrypted values' plaintexts.)

Step 3. The system then prepares an encrypted “unit size” Z by computing Z such that ZK≤V and (Z+1)K>V. The system proves this by providing the bank E(Z) and a trivial encryption E(K) and proving that E(Z)⊗E(K) [symbol] E(V) and (E(Z)⊖E(1))⊗E(K)>E(V). Thus there are K “units” of size Z in the breakdown. According to some embodiments, care must be taken so that V mod K is not too large, because this could skew the results. The system can even show the bank that value by revealing the verifiable result E(V)63 (E(K)⊗E(Z)), or proving that it is less than a small constant. Since K is public, the bank can refuse a K that is too small.

Step 4. For each element of the breakdown, the system prepares an interval proof of how many “units” that element comprises. It begins by calculating and revealing two integer constants aᵢ,bᵢ and their “trivial” encryptions E(aᵢ),E(bᵢ); the bank can verify these are correct encryptions. For example, aᵢ might be 10 and bᵢ 12, to show the result is between 10 and 12 units.

Step 5. The system completes the interval proof, showing that E(aᵢ)⊗E(Z)≤E(vᵢ)≤E(bᵢ)⊗E(Z). This proves that aᵢZ≤vᵢ≤bᵢZ. This bounds the value of the portfolio in bucket i without revealing any further information.

Step 6. Steps 4 and 5 are repeated for each “bucket” in the breakdown until the entire portfolio has been classified. The bank might check that Σ [symbol] aᵢ≤K≤Σ [symbol] bᵢ to be sure that the breakdown provided is appropriate.

### Other Measurements of Risk

Because of the flexibility of the mathematical operations that can be performed on the recipient bank's basket and the incoming basket, other, more complicated risk measurements are possible in some embodiments. While described above are examples are of completely linear functions, which permit the recipient to estimate the incoming baskets from the output risk characteristics and his own inputs, embodiment of the system provide for computation of polynomial functions of modest degree by using repeated multiplications of encrypted values to calculate exponents. This permits the computation of more complex risk analysis measurements.

### Cross-Clearing Markets

Each institution pays a premium to an investment bank for executing its trades on its behalf. Importantly, the institutions do not have the ability to directly take advantage of other liquidity in the market: where such liquidity exists, it benefits the intermediary banks.

According to another aspect, proposed is a new, related protocol for trading large basket orders that allows multiple institutions to trade their large baskets with one another in a larger marketplace. In one embodiment, the institutions all submit their baskets of trades by a particular clearing time; the baskets are then “combined” so that if one party is buying and another is selling, they trade against each other. Since it is unlikely that two parties will have equal and opposite matching orders, all of the baskets are placed into a liquidity “pool” where trades can be filled by any combination of the opposite orders.

Even if that is done, the problem remains: it is unlikely for there to be equal buying and selling demand for any particular security across the market. A naive solution might fill only some of the orders based on size or time submitted, or partially fill every order, then leave the excess demand unfilled. However, we can use the protocol described above in a novel solution that fills every order—thus achieving market equilibrium—in which many of the trades can take place directly among the investors who wish to buy and sell their securities, instead of via an intermediary bank.

### Example Protocol

For simplicity, assume that trade prices are determined externally, for example, by the last traded price of a security at a particular time of day or a volume-weighted average price (“VWAP”) of the security in the primary exchange. Other methods may also be employed. The trades are reported to the exchange at the prices determined by the market when they occur, whether all trades happen at a fixed time or are broken up over a period of time. (In the United States, recent SEC regulations known as “Reg NMS” require, among other things, that all trades take place at the “best execution price” available nationwide. This means that prices in a market implementing an the example protocol must follow quotations from the primary exchanges and electronic clearing networks, although there are exceptions for small transactions. Because block trades can be quite large, Reg NMS compliance is highly relevant to a real-life implementation of our work.)

Outside the US cash-traded equities market, trading prices are less highly regulated, and it is possible to construct an exchange in which both the prices and the quantities are encrypted, and trades occur only when prices are compatible (that is, the buyer's bid is greater than or equal to the seller's offer). Thorpe and Parkes detail a cryptographic securities exchange with encrypted quantities and prices (in “Cryptographic Securities Exchange”). For clarity of illustration, detailed is an exchange with only encrypted quantities, and outlined are the changes necessary to support prices in an alternative embodiment for example.

According to one example, a set of investment banks have agreed to provide liquidity by bidding on large baskets of equities (as they already do for institutional clients). Instead of banks individually bidding on each institution's basket, though, the banks bid on the entire remainder, and only one bid is accepted.

One implementation of an example process embodies the following steps:

Step 1. Each institution I₁, . . . , I [symbol] encrypts its basket of intended trades by encrypting the quantity to trade of each security listed in the exchange: positive to buy, negative to sell, or zero. They all publish their encrypted baskets. (The boxes under each I [symbol] column in Table I represent these encrypted baskets,)

Step 2. Anyone can combine the encrypted quantities from each basket into a basket of encrypted “remainders” representing the excess buying or selling demand for each security across the entire market. Column R in Table I illustrates the remainder basket after all the trades are cross-cleared.

Step 3. The example process continues by auctioning off the remainder, in one embodiment using a method as described above. The system has encryptions of all of the institutions' baskets, and thus an encryption of the remainder. Each institution sends its encrypted basket to every bidding bank. The banks can now verify that the encrypted remainder is a correct representation of the remainder.

Step 4. Each bank sends its encrypted inventory to the system; the system uses that information with the encrypted remainder to prove portfolio risk information to each bank as described above. For example, the system might reveal the total market value of the remainder, and a breakdown according to market capitalization, sector and liquidity. The banks verify this information using their encrypted remainder (computed by combining the institutions' encrypted baskets) and their own encrypted inventory.

Step 5. Each bank estimates its risk by accepting the remainder and sends a sealed bid to the system. For maximal security, the protocol should employ a cryptographic auction protocol that proves to each institution and each bank that the winning bank offered the highest bid but does not reveal any of the actual bids, whether winning or losing. This allows banks to keep their valuations secret from each other and also keeps the size of the remainder secret from the institutions, who do not need to know that information. Some secure cryptographic auction protocols that would be appropriate are described in Parkes, Rabin, Sheiber, Thorpe (“Practical Secrecy Preserving, verifiably correct and trustworthy auctions”); Bogetoft, Jakobson, Nielsen, Pagter, and Tuft (“Practical Implemenation of secure auctions based on multiparty integer computation”); Lipmaa, Asokan, and Niemi (Secure Vickrey auctions without threshold trust”). These references also include citations of still other secure auction protocols and security concerns relevant to implementing such a system.

Step 6. Once the bid is accepted, the banks' agreement to take on the remainder makes up the difference in liquidity: the system can clear the entire buying and selling demand for every institution by using a combination of other institutions' opposite orders and the bank's acceptance of the remainder.

Step 7. When the prices are fixed by the primary market, the banks may not be adequately compensated for their risk by the transaction price alone. After the transaction has taken place, the system can prove to each institution the fraction of shares that were efficiently cross-cleared and the fraction that needed to be traded with an intermediary bank for each equity, and of course the notional value represented by those shares.

One should appreciate that the entity operating the system and the intermediary bank accepting the remainder will be compensated for facilitating the exchange through fees and commissions. The appropriate payment mechanism for clearing this market is an open financial engineering question. Many possible payment schemes can he supported by our protocol: examples include charging a commission on the basis of every share traded, the value of every position traded, a per-equity surcharge to institutions whose trades were in the remainder (prorated by the total number of shares traded for that equity), etc. The fees for any of these mechanisms, and indeed, any linear function of the inputs, are easily supported in various embodiments with zero-knowledge proofs provided to each institution.

One should appreciate that one can extend the various protocols described to more expressive markets, for example, where banks choose in advance a subset of equities for which they will provide liquidity, or even a full combinatorial setting,

One should also appreciate a clear benefit of some embodiments: costs should be higher whenever securities are traded without full information, as happens when individual institutions trade large baskets with banks, providing only partial information about the baskets' contents. Some embodiments allows for a market to first clear opposite orders against each other, which is highly efficient because that available liquidity can be proven in zero knowledge. Only then are the remaining orders traded without full information as a single large basket. Overall, this means that far fewer shares need to be traded as part of a basket sold with partial information: the market should therefore be more efficient.

Alternate Completion (Steps 3-7) Each security in the market is bought and sold by a “market maker”, who has agreed in advance to supply liquidity to the market, typically in exchange for commissions or fees. At this point, the market operator reveals the remainder's quantities to the market makers, who “make up the difference” by buying or selling enough shares so that the market reaches equilibrium. The market Io operator then determines the price and forwards the final trade information to a clearing firm for post-execution clearing.

In the most interesting case of baskets of large block trades, it is unlikely one would find firms willing to blindly guarantee liquidity for such large amounts over all possible equities in a marketplace, however such an alternative may be implemented.

According to another embodiment, clearing any remainder involves accepting “chunks” of liquidity from various liquidity providers who do not necessarily need to trade the assets in these chunks, but are willing to liquidate them for a commission. In this model, each liquidity provider submits various encrypted baskets of assets to the exchange, each associated with an encrypted commission. The exchange first computes the remainder basket (as before) of all the assets required to clear all of the orders the parties who wish to trade already submitted to the exchange. Then, the exchange computes the optimal combination of “chunks” to reduce the site of the remainder basket and keep the commissions as low as possible. According to one embodiment, this yields a remainder of zero, and the market clears with a commission calculated by the sum of all of the commissions associated with the chunks used to clear the remainder. In another embodiment the remainder is made as small as possible, and other conventional methods of clearing the small remainder may be used. The commissions are allocated among the trading parties in accordance with published rules.

These embodiments can be combined with the other embodiments discussed, in which these chunks are used to reduce the remainder to a small size; that remainder is then either shopped around by the another model (its risk, or the way it changes risk in a counterparty's inventory, are communicated and bid on), or liquidated directly using another exchange.

### Pricing and Payment

As discussed any purchaser has enough information to calculate and quote a price to the institution for its basket. It can accurately assess the changes in risk on its inventory by accepting the basket, and by measuring those changes, estimate hedging costs for equities it will carry and execution costs for unwinding the trades it does not wish to keep.

If the cash value of the portfolio is revealed, the bank can quote a price based on that; if the skew is not revealed, then the bank can quote a price based on a discount factor or volume-weighted price after the transaction is agreed on. The institution can choose among the various banks' offers, and notify the winner. Once the transaction is complete, the winner will be able to verify that the information provided was correct by looking at the exact portfolio—but one should appreciate that an advantage of some embodiments is that the banks that do not win still have convincing proof that the information was correct; the institution can't favor one bank over another.

According to one aspect, two types of prices must be computed: the price at which each security is valued when the exchange clears, and the price that the third parties charge for providing the market-clearing liquidity. They are treated in turn, referring to the winning third party (which might be a consortium) as the investment “bank”. Note that if an embodiment is used independently between a single institution and one or more investment banks for proving characteristics about a single basket trade, the institution's basket functions as the remainder.

Because each of the securities in the exchange is presumed to be traded on a primary market, used in some embodiments is the common practice in block trading to allow the primary market to dictate a fair market price for the securities at the time of trading. The financial industry uses many reasonable methods for price determination in block trading—provided that the trading prices are determined in a manner exogenous to the exchange. Examples of these methods include average prices over time such as the volume-weighted average price (VWAP), or simply the midpoint of the bid and offer at the time the market clears, any of which may be employed, alone or together in some embodiments.

After proofs are obtained, third parties have learned enough information to calculate a price for the incoming basket. They can accurately assess the changes in risk on their own inventories if they accept the basket, and by measuring those changes, estimate hedging costs for equities it will carry and execution costs for unwinding the trades it does not wish to keep.

### Compensating the Liquidity Providers

The third party can be compensated in many ways; the simplest is for the bank to quote a brokerage commission that it accepts for executing the trades. If the bank perceives greater risk, the bank can charge a higher commission. According to other embodiments, other pricing mechanisms are possible: if the cash value of the portfolio is revealed, the bank can quote a price based on that; if the skew is not revealed, then the bank can quote a price based on a discount factor or volume-weighted price after the transaction is agreed on. The institution can choose among the various banks' offers, and notify the winner. Once the transaction is complete, the bank accepting the basket will he able to verify that the information provided was correct when it receives the remainder portfolio—but one should appreciate that an advantage of various embodiment is that the banks that do not win still have convincing proof that the information was correct: the institution can't favor one bank over another.

In one embodiment, another interesting possibility is for the liquidity providers to publish deterministically verifiable valuation functions for their risk premium calculations. Using these, they can submit a representative portfolio to the exchange, obtain the changes in risk on their portfolio, then the exchange runs their calculations on the encrypted risk data and publishes a verifiable, encrypted result. These results would then be used to prove the payments correct, or could even be used in a verifiable sealed-bid auction to prove which of the liquidity providers' calculations yielded the most competitive bid for liquidating the remainder.

### Simply Allocating Liquidation Costs According to One Example

In one example, the commissions for obtaining this liquidity from the third parties must now be distributed among the institutions participating in the exchange. One approach, which reveals very little, is to distribute the costs among the participants according to their proportion of the notional value of trading across the exchange. Since revealing the proportion of an institution's share of the volume across the exchange also allows the institution to compute that volume, the exchange operator reveals the total notional value traded and proves that amount correct using the encrypted baskets. Each institution can then compute its proportion of the notional value and pay its share of the commission. However, this scheme benefits institutions who take advantage of more of the liquidity provided by the outside parties.

### Fairly Allocating Liquidation Costs Example

While total cost sharing is simple and convenient, a more involved embodiment includes a “pay for what you use” model: each institution pays its share of the commission based only on the benefit it derived from the securities provided by the liquidity providers. In this method, institutions that use more of the remainder (instead of the other institutions) to fill their trades pay a greater share of the commission. At the extremes, an institution that trades securities which do not appear in the remainder pays nothing, while an institution who is the only one trading a particular security pays the entire share of the commission for that security.

One example refers back to Table B, assumes that each security trades at a price of S1, and the liquidity provider charged a commission of S9000. The notional values of the four institutions' baskets are S1800, S1100, S1500, and S500, respectively; the remainder basket's value is S900. The exchange operator then publishes the encrypted amounts of commission paid based on the pro rata notional value traded of each security: S3000 for ABC, S0 for DEF, S2000 for GHI, S1000 for JKL, and S3000 for MNO. The operator proves that their sum is the (public) total commission.

Next, the exchange operator proves the total trading interest for each security by publishing encrypted sums of the absolute notional value of the orders in each basket: 700 for ABC, 1600 for DEF, 400 for GHI, 900 for JKL, and 1300 for MNO. Then, using the above methods, the exchange operator can publish an encrypted breakdown of the commission to be paid per share. (Since the numbers do not divide evenly, the market operator can simply round up to the nearest integer and prove that the result is within a small error, that is, the difference between the total commission and the reported commission is small) In this case, the commissions work out to S429 per 100 shares of ABC, S0 per 100 shares of DEF, S500 per 100 shares of GHI, S112 per 100 shares of JKL, and S231 per 100 shares of MNO; this yields a total overcharge of S14 due to rounding error. (If verifiable operations over encrypted rationale are employed, even this rounding error can be eliminated at a constant factor of additional computation cost) The market operator proves that these encrypted prorated commissions are correct given the encrypted values already computed.

The market operator finally uses these encrypted prorated commissions to give each institution a verifiable share of its commission without revealing the magnitude of the securities traded by other traders or the composition of the remainder basket. For example, Institution I would pay

(5×429)−(3×0)−(0×500)−(2×112)−(8×231)=4217.

The others would pay S1358, S3103, and S336, respectively, for their share of the costs in liquidating the remainder.

Another alternative, and possibly a fairer method is inspired by the Vickrey auction. In such an embodiment, an institution's share of the commission would be based on its impact on the market versus the marginal economy without its basket. Thus, institutions who improved the market by submitting a basket with opposite interest from the remaining baskets would pay very little (or perhaps even be paid!). Institutions who made the market more unbalanced by submitting a basket with interest in the same direction the remaining baskets would pay a greater share of the commission, because its trades would only be filled by means of the liquidity providers.

### Keeping the Pool Safe

Although the above described examples are designed to provide transparency without revealing exploitable information, there remain ways in which unscrupulous traders might try to exploit the exchange.

One misuse of some embodiments of an exchange might be for institutions to use its guaranteed liquidity to unload especially high-risk or illiquid securities. If the exchange becomes filled with undesirable assets, then banks will be less likely to want to participate. One method of dealing with this problem is to adjust the pricing mechanism and in one example charging institutions according to the amount of the remainder basket their trades represent—if the pricing mechanism is correctly defined—will result in having institutions who submit less desirable portfolios pay more for their liquidation costs.

In another embodiment, it may be desirable to make sure that the baskets the institutions submit to the exchange meet basic criteria for acceptability and portfolio risk. Using the same portfolio risk analysis techniques described above, institutions can issue zero-knowledge proofs about the baskets they submit so that all can be confident that their trades are acceptable. In one example, this reduces the third-party liquidation costs, because the third parties will be more secure that they aren't going to receive a basket that has nice overall characteristics but might be comprised of less desirable individual securities.

Other common exploits, discussed above, associated with dark pools are less of a concern because of features of some embodiments that guaranty execution. Exploits such as probing for existing liquidity and baiting (where someone places an order and then retracts it) are less of a problem, since once an order is placed, it cannot be retracted, and learning that your order was filled reveals nothing about existing opposite interest—every order is filled. “Toxic dark pools” are known for being exploited.

### Strengthening Security

While the above solutions offer an appropriate degree of secrecy and are efficient to implement, some embodiments of the system do learn private data that could be revealed to others after the fact. It learns the trades that took place, which may be undesirable to certain institutions (notably hedge funds), and could learn something about the bank's inventory in the context of proving changes to the bank's risk without revealing the incoming portfolio characteristics directly. While the trades must eventually be reported to the exchanges and become a matter of public record, and no such information could have any bearing on a particular round of the exchange, this information still has value. Thus according to another aspect considered is how to mitigate the trust not to leak any information that we might place in the exchange operator.

According to one embodiment, an improvement to security involves the use of cryptographic commitments, where all data published or submitted to the system are first committed to, then revealed at a particular “closing time” when the bank receives its proofs. This would prevent a dishonest system from disclosing information from one institution to another (for example, that liquidity exists) or disclosing institutions' information to the bank before the bank commits to its own portfolio. One challenge with such a protocol is ensuring nonrepudiation, so that a party may not refuse to open a commitment later if it changes its mind. There are known methods to accommodate for nonrepudiation, and one should appreciate that the various embodiments disclosed herein, may be augmented by such methods. Parkes, Rubin, Sheiber, Thorpe (“Practical Secrecy Preserving, verifiably correct and trustworthy auctions”); Rabin, Servedio, and Thorpe (“Highly Efficient Secrecy Preserving Proofs of Correctness of Computations and Applications”) discuss the problem of commitments with nonrepudiation in various commercial protocols, that may be employed to extend some embodiments disclosed.

Further elimination of leakage is possible using secure computing infrastructure such as that described in “Trusted Computing Platforms” by Smith. This is the model adopted in works on cryptographic securities trading in Thorpe and Parkes and auctions proposals in Parkes, Rubin, Sheiber, Thorpe (“Practical Secrecy Preserving, verifiably correct and trustworthy auctions”); Rabin, Servedio, and Thorpe (“Highly Efficient Secrecy Preserving Proofs of Correctness of Computations and Applications”). In this scheme, specially designed hardware and software are trusted not to leak information, and are monitored for security; they are not trusted to give correct output. The cryptographic proofs described above guarantee correct output. Even in these settings, steganographic attacks are possible which leak information by “hiding” information in the protocol itself, often in predetermined bits of “random” help values. “Fair Zero-Knowledge,” introduced by Lepinski et al. describes a mechanism to combat such attacks and surveys. One should appreciate that these known methods may be used to augment some embodiments.

Still other cryptographic schemes offer complete security with an increase in complexity. According to one aspect, various proposed protocols could be employed using information-theoretically secure multi-party computation; the high stakes involved in multi-million dollar securities trading may justify the added complexity cost of such security guarantees.

In one such embodiment, all parties would need to participate in the entire protocol, and equities trading suffers substantially from “protocol completion incentive problems”—for example, if one of the parties realizes that it has made a poor trade, or that there is less liquidity than it expected, it could cause the entire protocol for everyone to be aborted by refusing to continue. This is obviously undesirable in fast-paced financial markets.

Finally, one should appreciate that perfect security is never attainable in real life where humans are involved: any dishonest party “in the know” within any institution or bank can always pick up the phone to deliver an out-of-hand information leak.

Illustrated are a number of interesting commercial cryptographic protocols that have immediate application in real-world securities transactions. They are efficient, straightforward to understand, and can be implemented using already accepted cryptographic primitives. They should not be read as limiting the scope of the invention. Other embodiments allow for block trading of securities that meets two market requirements: institutions can trade directly with each other when liquidity is available, while still having guaranteed execution for their entire order to limit portfolio and carrying risk. Employed is a combinatorial exchange model in some embodiments that is made tractable through external price discovery and a third party who provides necessary liquidity to achieve market equilibrium so that all orders are filled.

More general formulations of these protocols may be of independent interest. Consider an arbitrary function over a finite field with encrypted inputs and a prover who proves facts about the output of this function. Clearly, there are many functions for which a precise output reduces the space of possible inputs dramatically—an unintended consequence of revealing a single output. One embodiment provides provably correct yet approximate outputs using interval proofs, where exact results would reveal too much information.

The specific examples are generalized into a new class of price discovery. Constructed is a more general protocol that allows a buyer to evaluate a purchase on the basis of a change in the buyer's utility function, rather than calculating the utility of the good directly. This means that in many business settings, where direct revelation of the good in question might have negative consequences, a buyer can engage in “zero-knowledge due diligence” where the buyer can satisfy many concerns by learning about how her utility function changes based on incorporating the good into her possessions, without learning enough about the good to allow the information to be exploited. These settings might include the sale of a significant commercial building, a business unit of a large corporation, or, the trading of financial instruments.

Another embodiment may be useful in a combinatorial exchange setting, where buyers and sellers of substitutable goods can exchange first with each other, then reach equilibrium by purchasing from an intermediary. Uses of implementations of this protocol extend beyond finance enables real estate “pools” for exchanging commercial office space; temporary employment pools; or automobile or airplane fleet management.

Various embodiments according to the present invention may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor, including processors with multiple cores. It should be appreciated that one or more of any type computer system may be used to facilitate an exchange of block and/or basket of assets while preserving the secrecy of the underlying assets according to various embodiments of the invention. Further, the system may be located on a single computer or may be distributed among a plurality of computers attached by a communications network.

A general-purpose computer system according to one embodiment of the invention is configured to perform any of the described functions, including but not limited to performing secrecy preserving operations on secret values, encrypting, decrypting, calculating risk characteristics on secret assets, preserving secrecy of underlying assets while determining matched trades, executing a remainder basket generated from baskets of at least one secret asset, providing for submission of a plurality of baskets, generating proof information for calculations while preserving the secrecy of the underlying values in the computations, communicating, communicating privately, determining matched offers for sale, offers to purchase, offers to take short positions, offers to take long positions including where information associated with the offers is obfuscated. It should be appreciated, however, that the system may perform other functions, including performing obfuscation operations, including encryptions, commitments, multi-party computation, secret sharing, providing for a rule governing an exchange of assets, enabling a purchaser to verify determined operations, enabling a third party to verify calculated exchanges, providing for a purchaser to submit a representation of an inventory, providing for a purchaser to submit a obfuscated representation of an inventory, generating proof information for determined risk characteristics, reporting information associated with the exchange of assets, providing for the submission of a clearing basket, generating a clearing basket with at least one secret asset, determining an efficient solution for executing a remainder basket with at least one secret asset based on submitted clearing baskets while preserving the secrecy of the underlying assets, determining an efficient solution for executing a remainder basket based on clearing baskets and commission rates, determining risk characteristics for an asset portfolio using an invertible encryption operation, providing for the submission of an obfuscated quantity of zero for an asset listed in a basket, etc., and the invention is not limited to having any particular function or set of functions.

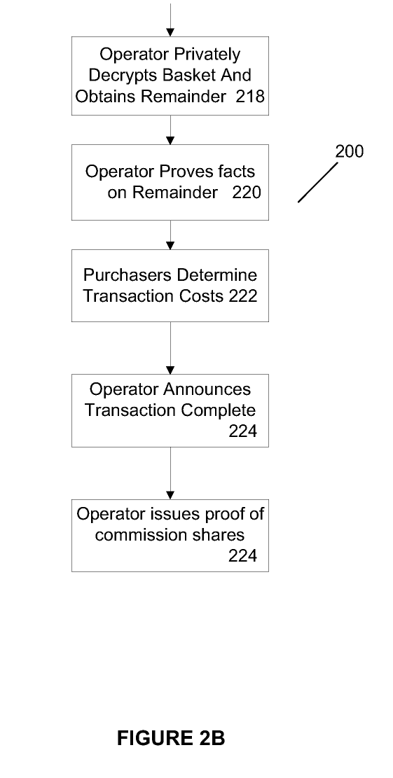

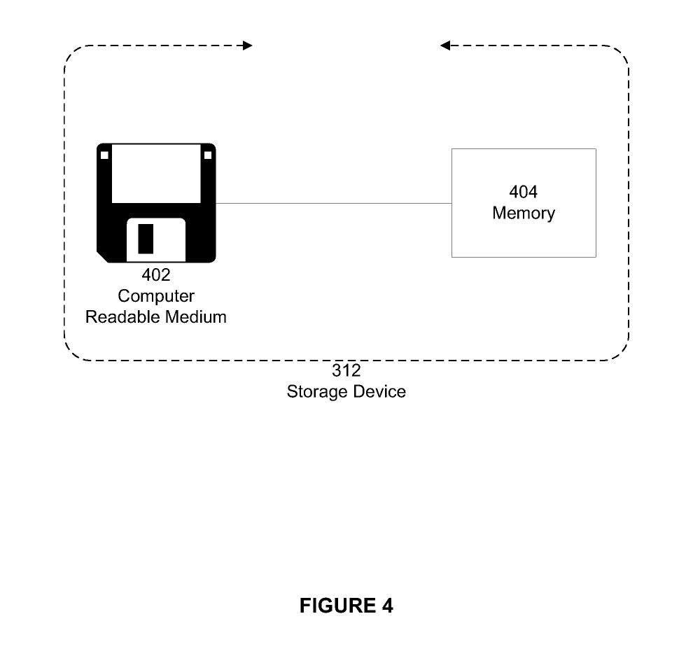

FIG. 3 shows a block diagram of a general purpose computer system 300 in which various aspects of the present invention may be practiced. For example, various aspects of the invention may be implemented as specialized software executing in one or more computer systems including general-purpose computer systems 504, 506, and 508 communicating over network 502 shown in FIG. 5. Computer system 300 may include a processor 306 connected to one or more memory devices 310, such as a disk drive, memory, or other device for storing data. Memory 310 is typically used for storing programs and data during operation of the computer system 300. Components of computer system 300 may be coupled by an interconnection mechanism 308, which may include one or more busses (e.g., between components that are integrated within a same machine) and/or a network (e.g., between components that reside on separate discrete machines). The interconnection mechanism enables communications (e.g., data, instructions) to be exchanged between system components of system 300.

Computer system 300 may also include one or more input/output (I/O) devices 304, for example, a keyboard, mouse, trackball, microphone, touch screen, a printing device, display screen, speaker, etc. Storage 312, typically includes a computer readable and writeable nonvolatile recording medium in which signals are stored that define a program to be executed by the processor or information stored on or in the medium to he processed by the program.

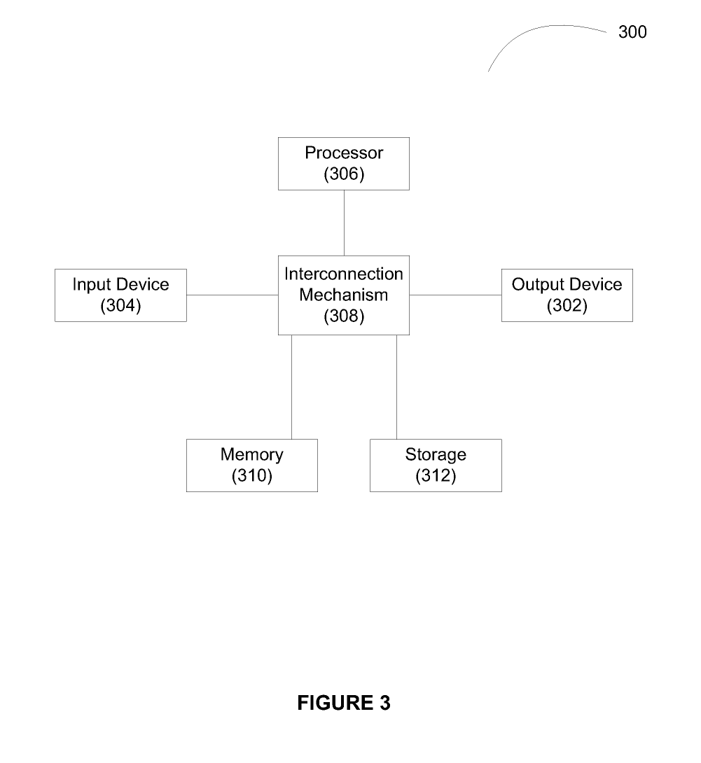

The medium may, for example, be a disk 402 or flash memory as shown in FIG. 4. Typically, in operation, the processor causes data to be read from the nonvolatile recording medium into another memory 404 that allows for faster access to the information by the processor than does the medium. This memory is typically a volatile, random access memory such as a dynamic random access memory (DRAM) or static memory (SRAM).

Referring again to FIG. 3, the memory may be located in storage 312 as shown, or in memory system 310. The processor 306 generally manipulates the data within the memory 310, and then copies the data to the medium associated with storage 312 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architectures or components that that shown in FIG. 3.

Computer system 300 may be a general-purpose computer system that is programmable using a high-level computer programming language. Computer system 300 may be also implemented using specially programmed, special purpose hardware. In computer system 300, processor 306 is typically a commercially available processor such as the well-known Pentium class processor available from the Intel Corporation. Many other processors are available, including for example, multi-core processors. Such a processor usually executes an operating system which may be, for example, the Windows-based operating systems (e.g., Windows Vista, Windows NT. Windows 2000 (Windows ME), Windows XP operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems similar to system 300. For instance, the system may be a distributed system (e.g., client server, multi-tier system) comprising multiple general-purpose computer systems. In one example, the system includes software processes executing on a system associated with a institution, or in another example a party wishing to sell assets in a secrecy preserving manner (e.g., a client computer system). These systems may permit the institution and or seller to submit a portfolio of assets including at least one secret asset (as well as a portfolio made entirely of secret assets) in order to solicit bids for the assets, to obfuscate information associated with the assets to preserve their secrecy, access proof information, risk information, among other functions. There may be other computer systems, such as those installed at an exchange operator's location that perform functions such as accepting blocks and/or baskets of assets including secret assets and/or offers, determining matched trades between secret assets while preserving the secrecy of the assets, determining a remainder, generating proof information for the determined trades and/or remainder, receiving encrypted asset information, posting proof information, decrypting information, providing for execution of a determined remainder, including accepting clearing baskets from bidders, determining an efficient allocation of commission costs based on submit clearing baskets, among other functions. There may be other computer systems, such as those installed at an bidder's location that performs other function, such as permitting a bidder to generate a clearing basket with at least one secret asset, to submit a clearing basket and commission request, to submit an obfuscated clearing basket and commission estimate, to verify proof information generated, verify remainder information, among other functions. As discussed, these systems may be distributed among a communication system such as the Internet. One such distributed network, as discussed below with respect to FIG. 5, may be used to implement various aspects of the present invention.

FIG. 5 shows an architecture diagram of an example distributed system 500 suitable for implementing various aspects of the present invention. It should be appreciated that FIG. 5 is used for illustration purposes only, and that other architectures may be used to facilitate one or more aspects of the present invention.

System 500 may include one or more general-purpose computer systems distributed among a network 502 such as, for example, the internet. Such systems may cooperate to perform functions related to the verifiably correct auction. In an example of one such system for conducting a secrecy preserving exchange of assets, one or more institutions operate one or more client computer systems 504, 506, and 508 through which secret asset information is submitted for use in the exchange, and where bidders for the secret assets may user one or more client computer systems 504, 506, and 508 to submit clearing baskets intended to fulfill and demand for sales or purchases of assets in a zero-knowledge fashion. In one example, any bidders and any sellers interface with the system via an internet-based interface.

In one example, a system 504 includes a browser program such as the Microsoft Internet Explorer application program through which one or more websites may be accessed. Further, there may be one or more application programs that are executed on system 504 that perform functions associated with the secrecy preserving exchange of assets. System 504 may include one or more local databases including, but not limited to, information relating to an exchange that is underway for a particular assets, block of assets and/or baskets of assets.

Network 502 may also include, as part of the system for conducting a secrecy preserving exchange of assets one or more server systems, which may be implemented on general purpose computers that cooperate to perform various functions of the system for conducting a secrecy preserving provably correct exchange of assets including encryption, obfuscation, decryption, generation of proof information, and verification of transaction outcomes, generation of combined portfolios, obfuscation of information associated with assets in a basket and/or block, determination of risk characteristics of assets, among other functions. System 500 may execute any number of software programs or processes and the invention is not limited to any particular type or number of processes. Such processes may perform the various workflows associated with a system for conducting a secrecy preserving provably correct exchange of secret assets.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1-20. (canceled)

21. A method for distributing baskets over a network to a clearing computer, the method comprising:
transmitting, by the clearing computer and to at least a first client computer and a second client computer, exchange details comprising a public encryption key and a clearing time;
prior to expiration of the clearing time:
receiving, over the network by the clearing computer and from the first client computer, a first encrypted basket, wherein the first encrypted basket comprises a first plurality of securities information encrypted using the public encryption key, wherein the first plurality of securities information comprises a first order specifying a first quantity and an identity of an asset;
receiving, over the network by the clearing computer and from the second client computer, a second encrypted basket, wherein the second encrypted basket comprises a second plurality of securities information encrypted using the public encryption key, wherein the second plurality of securities information comprises a second order specifying a second quantity and the identity of the asset;
upon the expiration of the clearing time:
decrypting, by the clearing computer, the first encrypted basket and the second encrypted basket to obtain the first decrypted basket and the second decrypted basket;
determining, using the first decrypted basket and the second decrypted basket, by the clearing computer, overlapping orders for the asset,
determining, using the first decrypted basket and the second decrypted basket, a remainder from the overlapping orders for the asset;
generating, by the clearing computer, at least one remainder basket for clearing the remainder, wherein the at least one remainder basket comprises an additional encrypted basket, wherein the additional encrypted basket comprises an additional order specifying an additional quantity and the identity of the asset, the additional quantity being calculated from the remainder from the overlapping orders for the asset;
generating, by the clearing computer, an assertion about at least one selected from a group consisting of the overlapping orders and the additional order;
generating, by the clearing computer, proof information for verifying the assertion, wherein the proof information comprises a computer-readable representation of data relating the assertion;
transmitting, by the clearing computer over the network, the proof information to a verification computer, wherein the verification computer verifies the assertion using the proof information and at least one selected from a group consisting of the first encrypted basket, the second encrypted basket, and the additional encrypted basket.

22. The method of claim 21, further comprising:
prior to expiration of the clearing time:
receiving, over the network by the clearing computer and from the first client computer, a first commitment value committing to the first encrypted basket;
receiving, over the network by the clearing computer and from the second client computer, a second commitment value committing to the second encrypted basket;
wherein upon the expiration of the clearing time:
making a first determination that the first encrypted basket was successfully decommitted by the first client computer, wherein the first determination is based, at least in part, on the first commitment value;
making a second determination that the second encrypted basket was not successfully decommitted by the second client computer;
in response to the second determination:
publishing, by the clearing computer, the second encrypted basket and the second commitment value;
after the publishing, receiving, by the clearing computer, confirmation of a successful decommit of the second encrypted basket from the first client computer,
wherein the clearing computer proceeds to decrypt the first encrypted basket and the second encrypted basket after receiving the successful decommit.

23. The method of claim 21, wherein the verification computer is one selected from a group consisting of the first client computer and the second client computer.

24. The method of claim 21, wherein the asset is at least one selected from a group consisting of a security, an equity, a fixed income asset, a cash equivalent, a debt security, a commodity, and a derivative asset.

25. The method of claim 21, wherein the first offer is one selected from a group consisting of an offer to sell, a bid to buy, an offer to enter a short position (a short sale), and a bid to cover a short position.

26. The method of claim 25, wherein the first quantity is positive if the offer is a bid to buy or a bid to cover a short position, and negative if the offer is an offer to sell or an offer to enter a short position (a short sale).

27. The method of claim 21, wherein the first offer includes a limit order.

28. The method of claim 21, wherein the first plurality of securities information further comprises at least two cash equivalent orders.

29. The method of claim 21, wherein verifying the assertion comprises performing a secrecy preserving operation on an encrypted value selected from a group consisting of the encrypted form of the first quantity, the encrypted form of the second quantity, and the encrypted form of the additional quantity.

30. The method of claim 29, wherein the secrecy preserving operation includes at least one operation selected from a group consisting of addition, subtraction, multiplication, equality determination, and comparison.

31. The method of claim 21, wherein the proof information further comprises an encrypted remainder generated by encrypting the remainder and wherein verifying the assertion comprises establishing that the encrypted remainder was computed correctly.

32. The method of claim 21, wherein the assertion comprises an assertion that a basket satisfies a mathematical constraint, wherein the basket is one selected from a group consisting of the first basket, the second basket, and the additional basket.

33. The method of claim 32, wherein the mathematical constraint satisfied by the basket is a constraint selected from a group consisting of bounding the sum of the notional absolute value of all orders in the basket, bounding the sum of the notional positive or negative value of all orders in the basket, bounding the quantity of the asset, and bounding a formula computed on the plurality of securities information in the basket.

34. The method according to claim 21, further comprising:
generating, by the clearing computer, a set of trades based on the first decrypted basket, the second decrypted basket, and the at least one remainder basket, wherein the set of trades is constructed to clear all orders in all baskets;
generating, by the clearing computer, a first assignment of a first subset of the set of trades to a first party and a second assignment of a second subset of the set of trades to a second party;
generating, by the clearing computer, a correctness assertion that the set of trades correctly clears all orders in all baskets and proof information verifying the correctness assertion; and
transmitting, by the clearing computer over the network, the correctness assertion and the proof information verifying the correctness assertion to the verification computer, wherein the verification computer verifies the correctness assertion using the proof information verifying the correctness assertion and at least one selected from a group consisting of the first encrypted basket, the second encrypted basket, and the additional encrypted basket.

35. The method according to claim 21, further comprising:
generating, by the clearing computer, a set of trades based on the first decrypted basket, the second decrypted basket, and the at least one remainder basket, wherein the set of trades is constructed to clear all orders in all baskets;
generating, by the clearing computer, a set of encrypted trades by encrypting each of the set of trades using the public encryption key;
generating, by the clearing computer, a correctness assertion that the set of trades correctly clears all orders in all baskets and proof information verifying the correctness assertion; and
transmitting, by the clearing computer over the network, the set of encrypted trades, the correctness assertion and proof information verifying the correctness assertion, to the verification computer, wherein the verification computer verifies the correctness assertion using the proof information verifying the correctness assertion and at least one selected from a group consisting of the set of encrypted trades, the first encrypted basket, the second encrypted basket, and the additional encrypted basket.

36. A non-transitory computer-readable medium having computer readable signals stored thereon that define instructions that, as a result of being executed by a clearing computer, instruct the clear computer to perform a method for distributing baskets over a network to the clearing computer, the method comprising:
transmitting, by the clearing computer and to at least a first client computer and a second client computer, exchange details comprising a public encryption key and a clearing time;
prior to expiration of the clearing time:
receiving, over the network by the clearing computer and from the first client computer, a first encrypted basket, wherein the first encrypted basket comprises a first plurality of securities information encrypted using the public encryption key, wherein the first plurality of securities information comprises a first order specifying a first quantity and an identity of an asset;
receiving, over the network by the clearing computer and from the second client computer, a second encrypted basket, wherein the second encrypted basket comprises a second plurality of securities information encrypted using the public encryption key, wherein the second plurality of securities information comprises a second order specifying a second quantity and the identity of the asset;
upon the expiration of the clearing time:
decrypting, by the clearing computer, the first encrypted basket and the second encrypted basket to obtain the first decrypted basket and the second decrypted basket;
determining, using the first decrypted basket and the second decrypted basket, by the clearing computer, overlapping orders for the asset,
determining, using the first decrypted basket and the second decrypted basket, a remainder from the overlapping orders for the asset;
generating, by the clearing computer, at least one remainder basket for clearing the remainder, wherein the at least one remainder basket comprises an additional encrypted basket, wherein the additional encrypted basket comprises an additional order specifying an additional quantity and the identity of the asset, the additional quantity being calculated from the remainder from the overlapping orders for the asset;
generating, by the clearing computer, an assertion about at least one selected from a group consisting of the overlapping orders and the additional order;
generating, by the clearing computer, proof information for verifying the assertion, wherein the proof information comprises a computer-readable representation of data relating the assertion;
transmitting, by the clearing computer over the network, the proof information to a verification computer, wherein the verification computer verifies the assertion using the proof information and at least one selected from a group consisting of the first encrypted basket, the second encrypted basket, and the additional encrypted basket.

37. The non-transitory computer-readable medium of claim 36, the further comprising:
prior to expiration of the clearing time:
receiving, over the network by the clearing computer and from the first client computer, a first commitment value committing to the first encrypted basket;
receiving, over the network by the clearing computer and from the second client computer, a second commitment value committing to the second encrypted basket;
wherein upon the expiration of the clearing time:
making a first determination that the first encrypted basket was successfully decommitted by the first client computer, wherein the first determination is based, at least in part, on the first commitment value;
making a second determination that the second encrypted basket was not successfully decommitted by the second client computer;
in response to the second determination:
publishing, by the clearing computer, the second encrypted basket and the second commitment value;
after the publishing, receiving, by the clearing computer, confirmation of a successful decommit of the second encrypted basket from the first client computer,
wherein the clearing computer proceeds to decrypt the first encrypted basket and the second encrypted basket after receiving the successful decommit.

38. The non-transitory computer-readable medium of claim 36, wherein the verification computer is one selected from a group consisting of the first client computer and the second client computer.

39. The non-transitory computer-readable medium of claim 36, the further comprising:
generating, by the clearing computer, a set of trades based on the first decrypted basket, the second decrypted basket, and the at least one remainder basket, wherein the set of trades is constructed to clear all orders in all baskets;
generating, by the clearing computer, a first assignment of a first subset of the set of trades to a first party and a second assignment of a second subset of the set of trades to a second party;
generating, by the clearing computer, a correctness assertion that the set of trades correctly clears all orders in all baskets and proof information verifying the correctness assertion; and
transmitting, by the clearing computer over the network, the correctness assertion and the proof information verifying the correctness assertion to the verification computer, wherein the verification computer verifies the correctness assertion using the proof information verifying the correctness assertion and at least one selected from a group consisting of the first encrypted basket, the second encrypted basket, and the additional encrypted basket.

40. The non-transitory computer-readable medium of claim 36, the further comprising:
generating, by the clearing computer, a set of trades based on the first decrypted basket, the second decrypted basket, and the at least one remainder basket, wherein the set of trades is constructed to clear all orders in all baskets;
generating, by the clearing computer, a set of encrypted trades by encrypting each of the set of trades using the public encryption key;
generating, by the clearing computer, a correctness assertion that the set of trades correctly clears all orders in all baskets and proof information verifying the correctness assertion; and
transmitting, by the clearing computer over the network, the set of encrypted trades, the correctness assertion and proof information verifying the correctness assertion, to the verification computer, wherein the verification computer verifies the correctness assertion using the proof information verifying the correctness assertion and at least one selected from a group consisting of the set of encrypted trades, the first encrypted basket, the second encrypted basket, and the additional encrypted basket.
